(19) United States
(12) Patent Application Publication
(10) Pub. No.: US 2002/0184096 A1
(43) Pub. Date: Dec. 5, 2002

(54) Portable terminal device for providing and obtaining advertisement information, advertisement providing method, advertisement obtaining method, advertisement distributing method and program therefor

(75) Inventors: Mihoko Kawahara, Yokohama (JP); Masaya Kimura, Yokohama (JP); Masaaki Mori, Yokohama (JP); Katzumi Hayashi, Yokohama (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/964,600

(22) Filed: Sep. 28, 2001

(30) Foreign Application Priority Data
Jun. 4, 2001 (JP) 2001-168512

(51) Int. Cl. G06F 17/60

(52) U.S. Cl. 705/14

(57) ABSTRACT

A portable terminal device of an advertisement medium in an advertisement providing system has the function of storing advertising information and the function of performing wireless communications such as Bluetooth, etc. When a consumer finds a person having interesting goods on or with him or her, the consumer requests to transmit information by wireless through a portable terminal. The portable terminal device of an advertisement medium receives the request to transmit the advertising information, and transmits the advertising information about the goods the advertisement medium has on or with. The advertisement medium has gained user entry in advance. Thus, the consumer can immediately obtain the advertising information about the goods which has been found in the street and interested the consumer.

### BACKGROUND OF THE INVENTION

1. Field of the Invention

The present invention relates to a portable terminal device having the function of providing advertising information, a portable terminal device having the function of obtaining advertising information, an advertisement providing method, an advertisement obtaining method, an advertisement distributing method, a program used for each device and method, and a storage medium storing the program.

2. Description of the Related Art

Conventionally, a place and opportunity where goods are sold to a consumer can be a shop, a mail order system using a catalog, an EC (electronic commercial activity) site through Internet, etc. In addition, means for advertising goods can be advertisements on an information medium such as television, radio, newspapers, magazines, etc., advertisements by media such as handbills, etc., banners for advertisements on a home page of Internet, etc.

With an increasing number of portable telephones, a larger number of consumers have carried portable terminals with them. In this example, a portable terminal refers to a portable telephone, an information processor terminal, etc. In addition, the wireless network technology such as Bluetooth, etc. has made outstanding progress, and information can be transmitted and received directly among portable terminals. The wireless network refers to a network through which voice and data can be transmitted and received using the wireless communications technology for portable terminals. The wireless communications technology currently used is not only the wireless communications technology used for portable telephones, but also Bluetooth, IrDA, Home RF, etc. that relate to the technology for portable information processors.

As the conventional technology for an advertisement distribution system using a portable terminal such as a portable telephone, etc., Japanese Patent Application No.H11-70075 (Japanese Patent Publication No.2000-268090) has disclosed an advertisement distribution system using a portable telephone displaying an advertisement through the distribution of advertising data from an advertisement management center to a portable terminal, and Japanese Patent Application No.H10-301426 (Japanese Patent Publication No.2000-134333) has disclosed an information distribution service system for distributing information as character information provided at a request of a user between a portable telephone and an information service server. Also, Japanese Patent Application No.H7-35152 (Japanese Patent Publication No.H08-193850) has disclosed an information display method and apparatus for distributing and displaying advertising information in the entire nation or advertising information in a local area to users. The conventional advertisement distributing method and apparatus aims at displaying an advertisement distributed by an advertisement distribution server such as an advertising management server on a portable terminal.

When a consumer requests to buy the same goods such as apparel, sundry goods, etc. as the goods other people have, the method of searching for the goods can be:

(1) asking the person having the desired goods to obtain the information about the place where the goods are sold, etc.

(2) asking a friend near the consumer, or taking a picture of the desired goods to show it later to a probable person who knows it.

(3) doing window-shopping later for the desired goods.

(4) searching media such as magazines, etc. and Internet for the information about the desired goods.

When the consumer searches for the desired goods, the method (1) is the most efficient, but it is difficult for most consumers to address a stranger for the information. In the methods (2) through (4), it is not probable that the consumer can be successfully provided with useful information about the desired goods such as the shops or the places where they can be obtained. Without a probable clue to the successful purchase of the desired goods, the consumer has to search a large number of shops, catalogs, sites, etc. for the goods. This wastes time, and in vain in most cases. Furthermore, the impression of the consumer fades with time, and the search becomes more difficult.

On the other hand, a seller cannot immediately satisfy the above mentioned request of the consumer using the conventional and common advertising method. As a result, the seller unfortunately loses the opportunity to sell the goods although the consumer intends to buy them.

### SUMMARY OF THE INVENTION

The present invention aims at immediately providing a consumer with advertising information about goods that the consumer finds on another person.

The advertisement providing method according to the present invention is realized by storing in a portable terminal device the advertising information about the goods an advertisement medium has on or with him or her, and transmitting the stored advertising information using a wireless signal upon receipt of a request to send the advertising information.

According to the present invention, a consumer can immediately obtain the advertising information about the goods a stranger in the street has on or with him or her. On the side of the seller of the goods, the advertising information can be immediately provided for the consumer interested in the goods, thereby enhancing an advertising effect.

The portable terminal device according to the present invention includes a wireless signal transmission and reception unit, a storage unit for storing the advertising information about the goods an advertisement medium has on or with him or her, and a control unit for transmitting the advertising information stored in the storage unit from the wireless signal transmission and reception unit upon receipt of a request to transmit the advertising information.

According to the present invention, the consumer can immediately obtain the advertising information about the goods a stranger in the street has on or with him or her. On the sales side of the goods, the advertising information can be immediately be provided for the consumer interested in the goods, thereby effectively enhancing the advertising effect. Furthermore, the seller can avoid losing the opportunity to sell goods to the consumer interested in the goods but knowing where to buy them.

The above mentioned advertisement providing method can be designed to provide information specifying the position in the network where the advertising information about the goods can be transmitted.

The above mentioned advertisement providing method can also be designed to provide an advertising reward for an advertisement medium who provides information for a consumer when the consumer who has received information from the portable terminal device of the advertisement medium views or purchases the goods according to the information.

With the configuration, the consumer can also obtain a reward by distributing the advertising information also as an advertisement medium. Thus, there is the probability that the number of consumers who have gained entry into advertisement media can increase by giving an advertising reward, thereby furthermore improving the advertising effect.

In addition to the advertisement specified information (URL, etc.) for designation of the Web site, etc. on which the advertising information is provided as described above, the storage unit of the portable terminal device of the advertisement medium can also store the information required when the goods are bought, for example, the type, color, price, etc. of the goods so that the consumer can directly obtain the advertising information from the portable terminal device of the advertisement medium.

The advertisement obtaining method according to the present invention requests the portable terminal device of an advertisement medium to transmit the advertising information, receives the advertising information about the goods the advertisement medium has on or with him or her transmitted from the portable terminal device of the advertisement medium, and displays the received advertising information.

According to the invention, when a consumer finds a person having on him or her interesting goods in the street, etc., the consumer requests the advertising information to be transmitted, and can obtain the advertising information about the desired goods. As a result, it is not necessary for the consumer to take much time in searching the advertising information in the magazines, through Internet, etc.

The above mentioned invention can also be designed to receive plural times the user-specified information of the advertisement medium transmitted from the portable terminal device of the target advertisement medium when the advertisement medium issues plural times a request to transmit the advertisement in the state in which a wireless signal is receivable, thereby limiting the number of advertisement medium according to the received user-specified information.

With the configuration, the number of advertisement medium can be limited by receiving plural times the user-specified information about the advertisement medium in the vicinity of the target advertisement medium. Thus, the advertisement medium having on him or her the goods interesting the consumer can be specified, and the advertising information about the target goods can be provided without fail.

The above mentioned invention can also be designed to request the advertising information to be transmitted with a profile of the advertisement medium having on him or her the goods interesting the consumer, and the user-specified information received from the advertisement medium specified.

With the configuration, the number of advertisement medium can be limited using the profile although there are a large number of advertisement medium in the wireless signal receivable area, thereby providing the advertising information about the goods requested by the consumer without fail.

In the above mentioned invention, the portable terminal device (of an advertisement medium or a consumer) can have the function of performing the wireless communications with a wireless base station in a portable telephone network, and the function of performing the wireless communications with another portable terminal device. Thus, the advertising information can be easily distributed and received using a portable telephone, etc.

The advertisement distributing method according to the present invention stores plural pieces of advertising information, receives a user entry of an advertisement medium, distributes the advertising information about the goods to the portable terminal device of the advertisement medium who has gained entry into registered users, and retrieves and distributes the corresponding advertisement upon receipt of a request to view the advertisement according to the advertising information transmitted from the portable terminal device of the advertisement medium to the portable terminal device of the consumer.

According to the present invention, when a consumer becomes interested in the goods of a person in the street, etc., the consumer transmits a request to send the advertising information, receives the advertising information transmitted from the portable terminal device of the advertisement medium, and sends a request to view the advertisement according to the advertising information to the advertisement distribution device storing plural pieces of advertising information, thereby immediately obtaining the advertisement of the goods. On the goods selling side, since the advertising information can be immediately transmitted to a consumer interested in the goods, the advertising effect can be greatly improved.

Furthermore, the present invention can also be designed such that a consumer can receive the user identification about an advertisement medium from the portable terminal device of the advertisement medium, and the retrieval condition of the goods specified by the consumer and the user identification about the advertisement medium can be transmitted to the advertisement distribution device, thereby issuing a request to view the advertisement.

With the configuration, the retrieval condition of the goods interesting the consumer, for example, the type, color, etc. of the goods and user-specified information can be transmitted to the advertisement distribution device. Therefore, although there are a large number of advertisement medium around the consumer, the advertisement medium can be appropriately specified and the advertising information about the goods can be obtained.

The advertisement distributing method according to the present invention stores plural pieces of advertising information, distributes the advertising information about the goods requested by an advertisement medium to the portable terminal device of the advertisement medium, and provides an advertising reward for the advertisement medium who provides the advertising information when a consumer receiving the advertising information views or buys the goods according to the advertising information transmitted from the portable terminal device of the advertisement medium to the portable terminal device of the consumer.

According to the present invention, the consumer can obtain a reword by distributing the advertising information as an advertisement medium. Furthermore, since there can be an increasing number of persons who gain entry into registered advertisement medium by allowing an advertising reward, the advertising effect can be greatly improved.

The advertisement distributing method according to the present invention stores plural pieces of advertising information, accepts user entries of an advertisement medium, distributes the advertising information about the goods to the portable terminal device of the advertisement medium who has gained entry into registered users, and distributes to the portable terminal device or the advertisement medium of the portable terminal device of the consumer a program for realizing the function of requesting the transmission of advertising information or the function of transmitting advertising information between the portable terminal device of the advertisement medium and the portable terminal device of the consumer.

According to the invention, for example, it is possible to download into the portable terminal device of the advertisement medium or the portable terminal device of the consumer a program for realizing the function of requesting the transmission of advertising information or the function of transmitting advertising information between the portable terminal device of the advertisement medium and the portable terminal device of the consumer. Therefore, it is not necessary for the terminal devices to prepare the function of requesting the advertising information to be transmitted. Furthermore, although the program is changed, the new program can be easily downloaded into the portable terminal device of the advertisement medium or the portable terminal device of the consumer.

### BRIEF DESCRIPTION OF THE DRAWINGS

FIG. 1 shows the basic configuration of an embodiment of the present invention;

FIG. 2 shows the distribution of an advertisement between a consumer and an advertisement medium;

FIG. 3 shows the configuration of the advertisement providing system according to an embodiment of the present invention;

FIG. 4 shows the configuration of the portable terminal device;

FIG. 5 shows the configuration of a user management server;

FIG. 6 shows the configuration of user personal information;

FIG. 7 shows the configuration of an advertising management server;

FIG. 8 shows the configuration of advertising management information;

FIG. 9 shows the configuration of a sales management server;

FIG. 10 shows the configuration of goods management information;

FIG. 11 shows the configuration of a logging server;

FIG. 12 shows an issue of an advertisement request by a seller;

FIG. 13 shows the case in which an advertising management server is provided in addition to an application service provider ASP server;

FIG. 14 shows the procedure of gaining entry into registered users in the user management server;

FIG. 15 is a flowchart of the process of gaining entry into registered users in the user management server;

FIG. 16 shows the procedure of an advertisement medium obtaining advertising data;

FIG. 17 is a flowchart of the process of obtaining advertising data in the portable terminal device of an advertisement medium.

FIG. 18 is a flowchart of the process of distributing advertising data in the advertising management server;

FIGS. 19A and 19B show examples of response data;

FIG. 20 shows an example of an advertisement management table;

FIG. 21 shows an advertisement management table for use in distributing a local advertisement of a distributor;

FIG. 22 is a flowchart of the process of updating advertising data in the portable terminal device of an advertisement medium;

FIG. 23 shows the procedure of a consumer viewing an advertisement;

FIG. 24 is a flowchart of the process of requesting to transmit advertising data in the portable terminal device of a consumer;

FIG. 25 is a flowchart of the process of distributing advertising data in the portable terminal device of an advertisement medium;

FIG. 26 shows the case in which advertising data is transmitted to a consumer based on the user ID and the retrieval condition;

FIG. 27 shows the case in which the optimum advertising data is transmitted to a consumer based in the profile of a consumer;

FIG. 28 is a flowchart of the retrieving process based on the user ID of an advertisement medium and the retrieval condition specified by a consumer;

FIG. 29 is a flowchart of the process of transmitting the optimum data to a consumer based on the profile of a consumer;

FIGS. 30A through 30D show the user profile and the retrieval condition;

FIG. 31 shows a menu screen of the portable terminal device of a consumer;

FIG. 32 shows the case in which a point is given to an advertisement medium when a consumer views the advertisement;

FIG. 33 shows the case in which a point is given to an advertisement medium when a consumer visits the shop;

FIG. 34 is a flowchart of the process of adding a point by a point management unit;

FIG. 35 shows a sequence when advertising data is provided based on the profile of a consumer;

FIG. 36 is a flowchart of limiting the number of advertisement medium according to the second embodiment of the present invention;

FIG. 37 shows the procedure of viewing an advertisement according to the third embodiment of the present invention;

FIG. 38 is a flowchart of the advertisement distributing process according to the third embodiment of the present invention;

FIG. 39 shows the retrieval condition containing a profile of an advertisement medium; and

FIG. 40 shows a storage medium.

### DESCRIPTION OF THE PREFERRED EMBODIMENTS

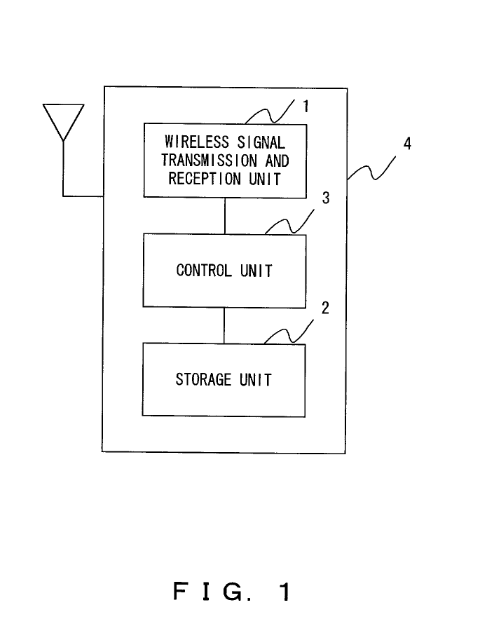

FIG. 1 shows the basic configuration of a portable terminal device 4 according to the present invention. The portable terminal device 4 comprises a wireless signal transmission and reception unit 1, a storage unit 2 for storing advertising information about the goods an advertisement medium has on or with him or her, and a control unit 3 for transmitting the advertising information stored in the storage unit 2 from the wireless signal transmission and reception unit 1 upon receipt of a request to transmit the advertising information.

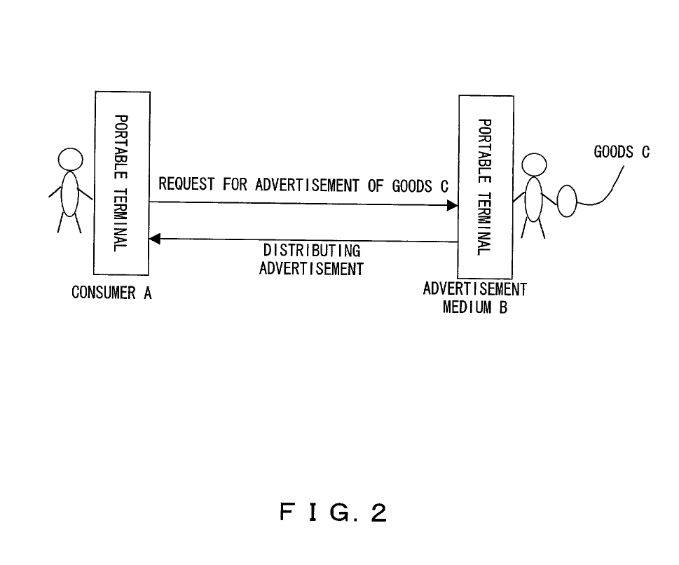

An example of distributing an advertisement between an advertisement medium and a consumer using the portable terminal device 4 is described below by referring to FIG. 2.

A portable terminal device owned by an advertisement medium B stores, for example, the advertising information (for example, the information designating the Web site on which the advertising information about the goods is provided) about the goods C that an advertisement medium has on or with him or her. When a consumer A finds the advertisement medium B and requests to distribute an advertisement, the advertising information stored in the portable terminal device of the advertisement medium B is transmitted. The portable terminal device of the consumer A requests the advertisement distribution device connected to the network to view the advertisement according to the received advertising information.

According to the present embodiment, the consumer can immediately obtain the advertising information about the goods a person in the street has on or with him or her. On the goods selling side, the advertising information can be immediately provided for the consumer interested in the goods, thereby greatly improving the advertising effect.

Furthermore, the selling side can avoid losing the opportunity to sell goods to a consumer who is interested in goods but does not know where to buy them.

The present invention is described below in detail by referring to the attached drawings.

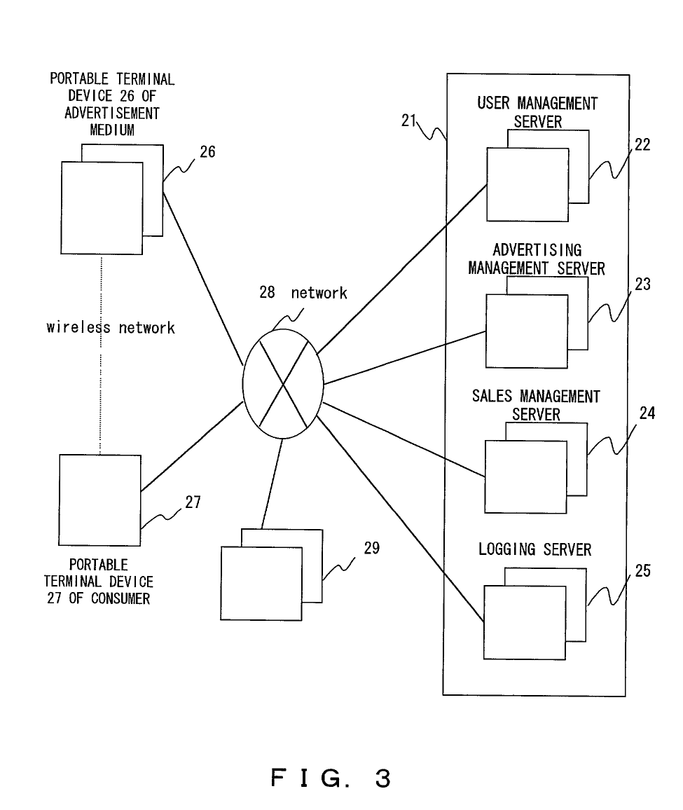

First, the outline of the advertisement providing system according to an embodiment of the present invention is described below by referring to FIG. 3. One of the objects of the advertisement providing system of an embodiment of the present invention is to easily and immediately obtain by a consumer walking in the street an advertisement from a consumer also walking in the street. To obtain the advertisement of the desired goods by issuing a request from the consumer, it is necessary that there is an advertisement medium for distributing an advertisement near the consumer. To attain this, it is necessary to realize a system in which sellers provide advertisements, consumers and advertisement medium participate as users, a number of sellers enter the advertisements of a number of goods, and a number of users can distribute and receive the advertisements.

The advertisement providing system is realized by, for example, an application service provider ASP server 21 (FIG. 3) for entering an advertisement medium, distributing the advertising information about goods, etc.

The seller who provides an advertisement, for example, gives a reward to a distributor (advertisement medium) of an advertisement by adding a point when the advertisement is effectively used through the system. Thus, it is expected that an increasing number of advertisement medium enter the advertisement providing system. Therefore, the seller can effectively provide at a low cost the advertisement for consumers that are probable buyers of goods.

The application service provider ASP server 21 can collect a part of the points issued by the seller as the rebate, obtain a profit from an advertisement fee different from that provided for the consumer by the seller such as a banner advertisement to the site of the application service provider ASP server.

For a consumer who uses the advertisement can immediately obtain the information about the desired goods free of charge, and an advertisement medium who distributes an advertisement can obtain a reward by distributing the advertisement.

Furthermore, when a common carrier realizes the application service provider ASP server 21, a large profit is expected from the communications fees of the users.

To realize the above mentioned system, the application service provider ASP server 21 is provided as the center unit of the advertisement providing system in the network. The application service provider ASP server 21 comprises a user management server 22 for entering consumers and advertisement medium as registered users participating the advertisement providing system and managing the points, an advertising management server 23 for managing the advertising information requested by the seller, a sales management server 24 for managing the goods information about the goods to be advertised, and a logging server 25 for storing various logs.

When a consumer participates in the advertisement providing system as a user, either the consumer directly accesses and enters the entry site of the user management server 22, or the shop enters a consumer who visits the shop as a registered user. The user management server 22 gives a rebate to the shop which enters a consumer as registered user based on the number of entered users. The entry of a consumer is performed only once, and the entered consumer can optionally distribute and receive advertisements.

As shown in FIG. 3, the advertisement providing system according to the first embodiment of the present invention comprises the application service provider ASP server 21, a portable terminal device 26 of an advertisement medium, a portable terminal device 27 of a consumer, and a seller/maker server 29, and they are connected through a network 28, for example Internet, etc.

The application service provider ASP server 21 comprises a user management server 22 for managing the information about the user entered as an advertisement medium, an advertising management server 23 for managing the advertising information entered by the seller, a sales management server 24 for managing the information about sold goods, etc., and a logging server 25 for managing an access log of a consumer and an advertisement medium. The advertising management server 23, the sales management server 24, and the logging server 25 are provided separately from the application service provider ASP server 21, and they can be connected through a LAN and the other network 28. Furthermore, each server can be configured by a plurality of servers.

The portable terminal device 26 of an advertisement medium can be a portable computer such as a portable telephone having the function of performing wireless communications such as a Bluetooth, a PDA, etc., and has the function of accessing the application service provider ASP server 21 through the network 28, and the function of transmitting to the portable terminal device 27 of a consumer by wireless the advertising information about the goods an advertisement medium has on or with him or her, or the URL, etc. (advertisement specified information) of the Web site of Internet through which the advertising information is provided.

The portable terminal device 27 of a consumer is also a portable telephone and a portable computer, and has the function of accessing the application service provider ASP server 21 through the network 28, and the function of requesting the portable terminal device 26 of an advertisement medium to transmit the advertising information by wireless. The portable terminal device 27 of a consumer in a predetermined wireless area and the portable terminal device 26 of an advertisement medium can directly communicate with each other by wireless.

The seller/maker server 29 has the function of entering the advertising information, etc. in the application service provider ASP server 21 through the network 28, etc.

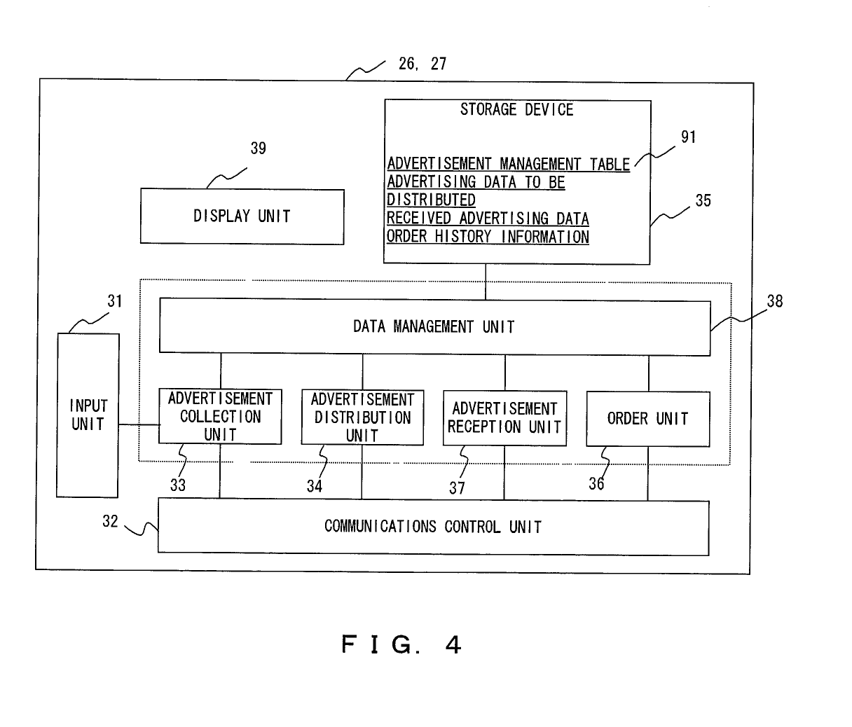

FIG. 4 shows the configuration of a portable terminal device used as the portable terminal device 26 of an advertisement medium or the portable terminal device 27 of a consumer.

An input unit 31 inputs a telephone number, a goods code, a character, etc. A method of inputting a goods code can be a method of adding a bar code scanner to read the bar code of goods, a method of adding an IC chip (RFID, etc.) storing the goods code to the goods to read the goods code stored in the IC chip without touching it, a method of inputting the goods code by a user, etc. A communications control unit 32 has the function of transmitting and receiving a wireless signal by a portable telephone, Bluetooth, etc.

An advertisement collection unit 33 and an advertisement distribution unit 34 have the functions required when the present device functions as the portable terminal device 26 of an advertisement medium. The advertisement collection unit 33 is used to download advertising data from the application service provider ASP server 21. The advertisement distribution unit 34 transmits the advertising data (advertising information) stored for distribution in a storage device 35 of the device to the portable terminal device 27 of a consumer using a wireless signal.

An order unit 36 and an advertisement reception unit 37 have the functions required when the present device functions as the portable terminal device 27 of a consumer. The order unit 36 requests the portable terminal device 26 of an advertisement medium to distribute advertising data. The advertisement reception unit 37 receives the advertising data transmitted by wireless from the portable terminal device 26 of an advertisement medium.

The storage device 35 stores the advertising data for distribution from the application service provider ASP server 21, the advertising data received from the portable terminal device 26 of an advertisement medium, the order history information, etc.

A data management unit 38 controls the storage or the read of the advertising data received by the advertisement collection unit 33, the advertisement distribution unit 34, the order unit 36, the advertisement reception unit 37, etc. or the advertising data to be distributed in the storage device 35.

The block (indicated by the dotted lines shown in FIG. 4) including the advertisement collection unit 33, the advertisement distribution unit 34, the order unit 36 the advertisement reception unit 37, and the data management unit 38 is realized by, for example, an advertisement distribution and reception program. The advertisement distribution and reception program can be installed in a portable terminal device in advance, and also can be downloaded by the user from the application service provider ASP server 21 when a user entry is performed.

Described below is the case in which the user of a portable terminal device gains a user entry in the application service provider ASP server 21.

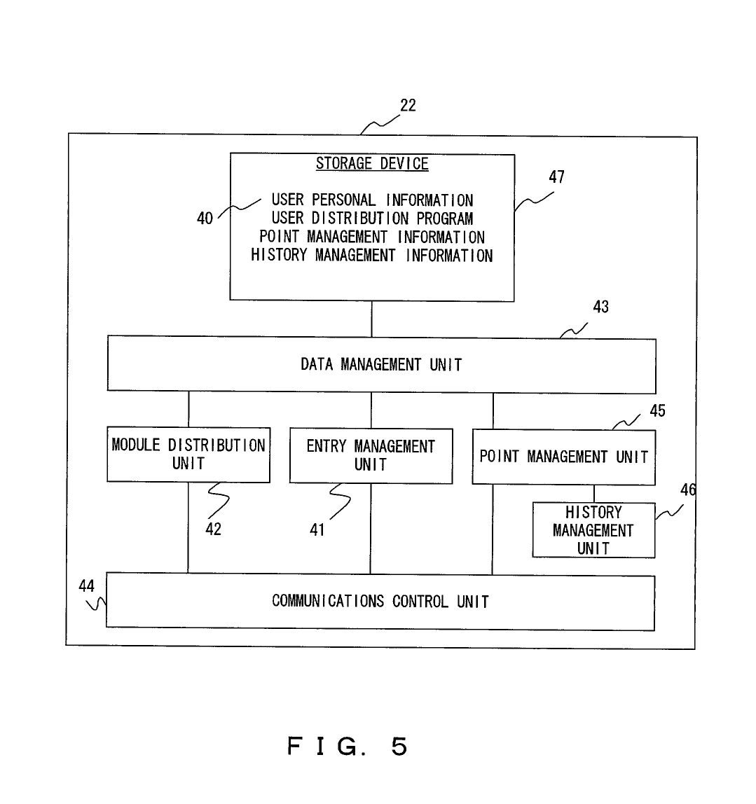

FIG. 5 show the configuration of the user management server 22 of the application service provider ASP server 21 for managing user information.

A entry management unit 41 accepts an application for an entry from a user, gives a user who has gained a user entry an user ID, and instructs the data management unit 43 to distribute a distribution program for a user.

A module distribution unit 42 receives a request of a data management unit 43 when a user entry is completed, and instructs a communications control unit 44 to distribute the advertisement distribution and reception program to the user.

Upon receipt of a notification of an acquired point from another management server, a point management unit 45 manages an accumulated point of a corresponding advertisement medium, computes an advertising reward, instruct to make a payment, etc. A history management unit 46 is located in a lower order position of the point management unit 45, and manages a point acquisition history from an advertisement medium ID assigned to an advertisement medium through the user entry, a goods code, a notification of an issue of a point, etc.

The data management unit 43 manages the data processed by the entry management unit 41, the module distribution unit 42, the point management unit 45, etc.

A storage device 47 stores user personal information 40 about an entered user, a program to be distributed to the user, an acquired point for each user, a point acquisition history for each user, etc.

The point management unit 45 is notified of the user ID of an advertisement medium and the number of points given on each condition from the advertising management server 23 when a consumer first accesses according to the advertising information obtained from an advertisement medium, from the sales management server 24 when a consumer purchases goods according to the advertising data obtained from an advertisement medium and finishes the payment, and from the logging server 25 when a consumer provided with advertising data from an advertisement medium visits the shop before accessing the advertising management server 23. The point management unit 45 accumulates the number of points for each advertisement medium, notifies each advertisement medium by mail, etc. when a predetermined number of points is reached, and transfers an advertising reward to an account entered in advance, etc. of the advertisement medium.

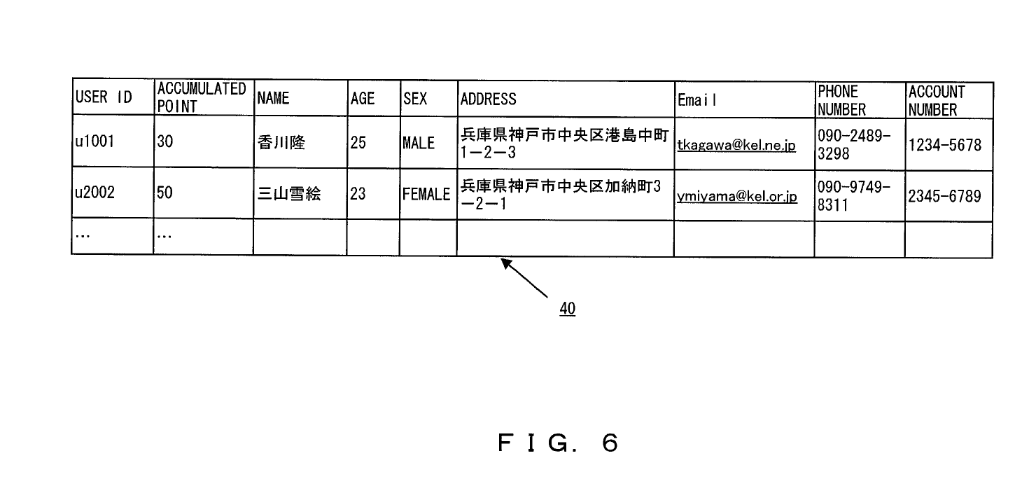

FIG. 6 shows the data configuration of the user personal information 40 managed by the user management server 22.

As shown in FIG. 6, the user personal information 40 comprises data such as a user ID given to an entered user, an accumulated value of points indicating the total number of points acquired by the user, a user name, age, sex, address, E-mail address, phone number, bank account number, etc.

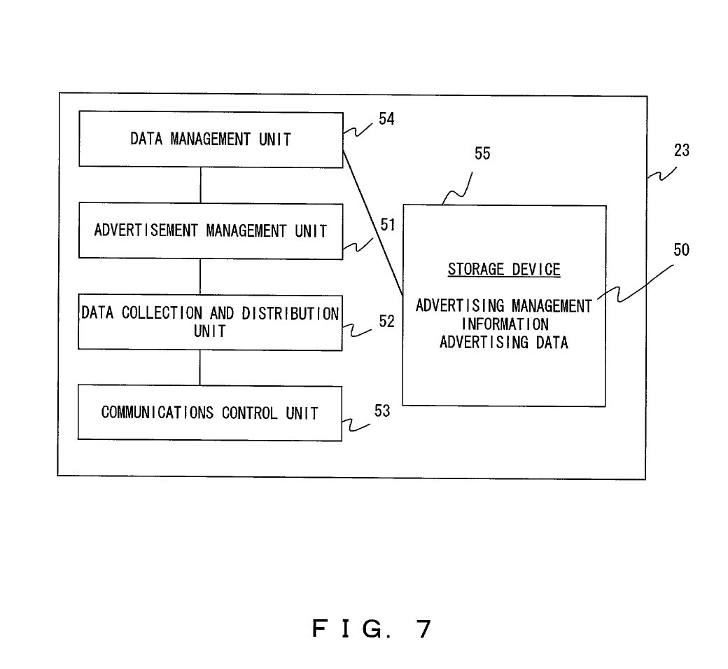

FIG. 7 shows the configuration of the advertising management server 23. An advertisement management unit 51 enters and manages an advertisement for which a request to advertise is received from the seller, and provides advertising data at a request from the consumer.

A data collection and distribution unit 52 collects advertising data from a seller, and distributes advertising data to a consumer.

A communications control unit 53 transmits and receives data among the seller/maker server 29, the portable terminal device 27 of a consumer, and the portable terminal device 26 of an advertisement medium through the network 28.

A data management unit 54 controls the write and the read of the advertising data managed by the advertisement management unit 51 or the advertising management information for management of the advertising data to and from a storage device 55.

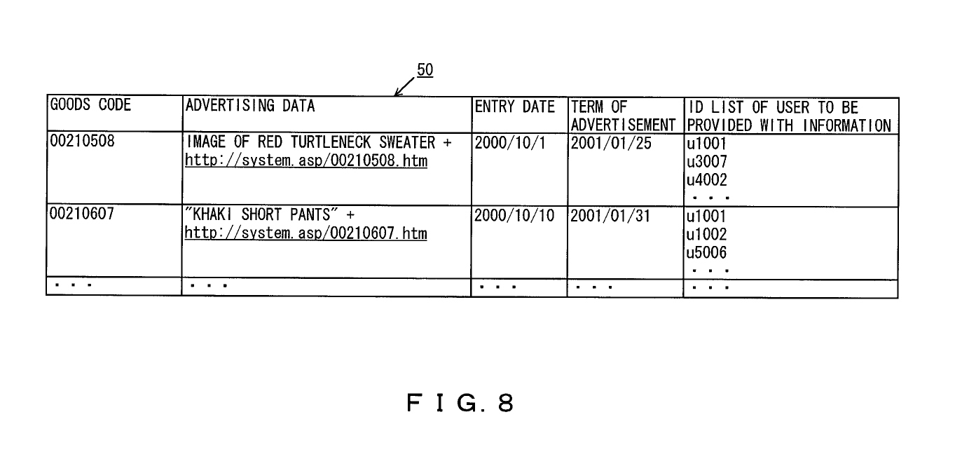

FIG. 8 shows the data configuration of an advertising management information 50 managed by the advertising management server 23.

The advertising management information 50 comprises a goods code, the information about the advertising data, the entry date of the advertising data, the term of the advertisement, and the user ID (the user ID of the advertisement medium) to which the advertising data is distributed. When the advertising data is entered on the Web site of the seller or the maker, the URL of the Web site is recorded as the information about the advertising data of the advertising management information 50.

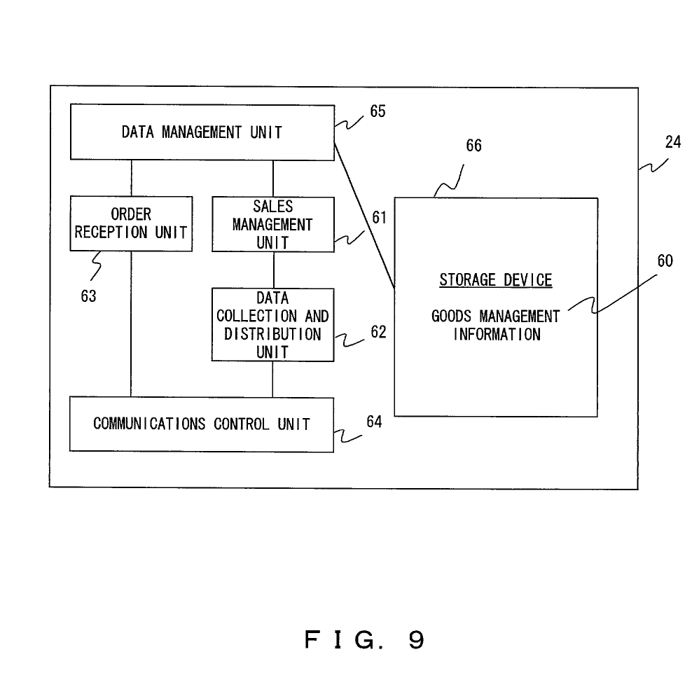

FIG. 9 shows the configuration of the sales management server 24. The sales management unit 61 manages the information about the goods such as a goods code, goods name, the points of the goods, the goods information, the stock, etc. If a consumer buys goods from a shop according to an opportunity, that is, according to the advertisement of a specific advertisement medium, then the point set for the goods by the point management unit 45 of the user management server 22 is notified as the point acquired by the advertisement medium.

A data collection and distribution unit 62 controls the collection and the distribution of goods management information. That is, the data of the goods code, the goods name, the price, etc. is obtained from a seller or a maker, or the goods management information is distributed to another server.

An order reception unit 63 accepts an order from a consumer through an electronic transaction. A communications control unit 64 transmits and receives goods information to and from the seller/maker server 29 through the network 28.

A data management unit 65 manages the data processed by the sales management unit 61, the order reception unit 63, etc. The data management unit 65 stores the goods management information generated by the sales management unit 61, or the order information in the order reception unit 63 in a storage device 66.

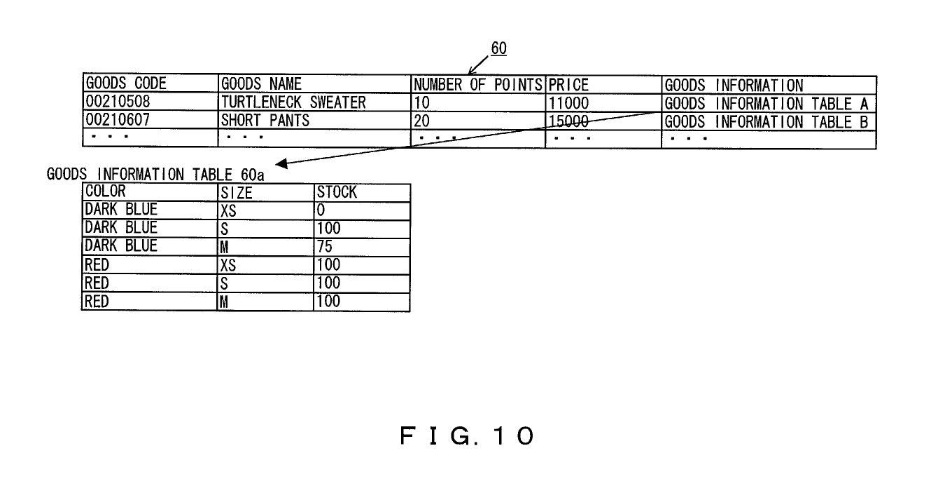

FIG. 10 shows the configuration of a goods management information 60 managed by the sales management server 24.

The goods management information 60 is configured by a goods code, a goods name, the number of points given to the advertisement medium through which goods are purchased, a price, and goods information as shown in FIG. 10. The goods information stored the information indicating a goods information table 60a. The goods information table 60a stores the color, size, amount of stock, etc. of the goods.

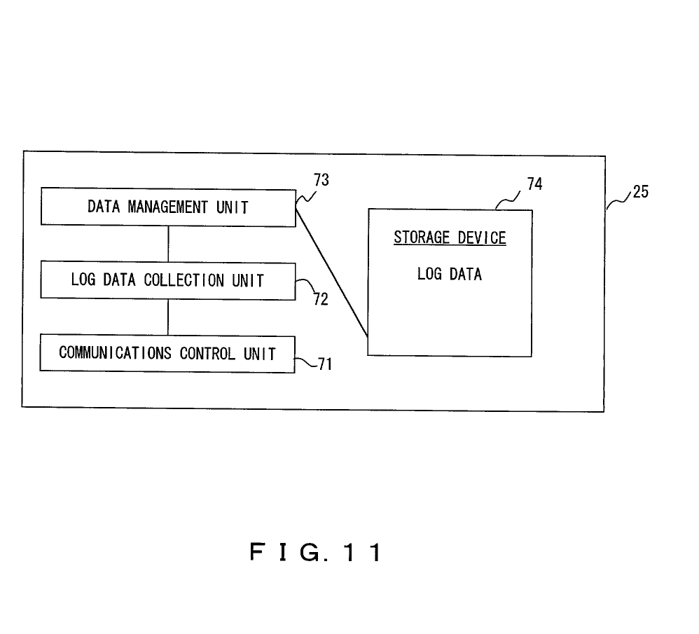

FIG. 11 shows the configuration of the logging server 25. A log data collection unit 71 collects the log data of an access log from another server. A communications control unit 72 transmits and receives log data through the network 28. A data management unit 73 manages log data by user. A storage device 74 stores log data under the control of the data management unit 73.

The logging server 25 performs a logging process at the following timing to identify a distributor of an advertisement. An advertisement is distributed for each item. However, when advertisements of a plurality of items are simultaneously received from advertisement medium, the plurality of advertisements simultaneously received from the same advertisement medium are collectively logged as one group.

For example, when a consumer displays a menu of a list of received advertisements, the advertisement distribution and reception program of the portable terminal device 27 of a consumer transmits the contents to the logging server 25 of the application service provider ASP server 21 for logging. This refers to a record of the consumer first recognizing the goods an advertisement medium has on or with him or her.

When a received advertisement is selected, the advertisement distribution and reception program transmits the contents to the logging server 25 of the application service provider ASP server 21 for logging. When a point is given to the advertisement medium only by the consumer seeing the advertisement, the logging server 25 records the log at this time, notifies the point management unit 45 of the user management server 22 of it, and gives the point to the advertisement medium. In this case, the value of the point is small considering a shop-visiting point and a goods purchase point to be added.

Described below is the operation of the advertisement providing system with the above mentioned configuration. Described first is the case in which a request to advertise goods is issued to the application service provider ASP server 21.

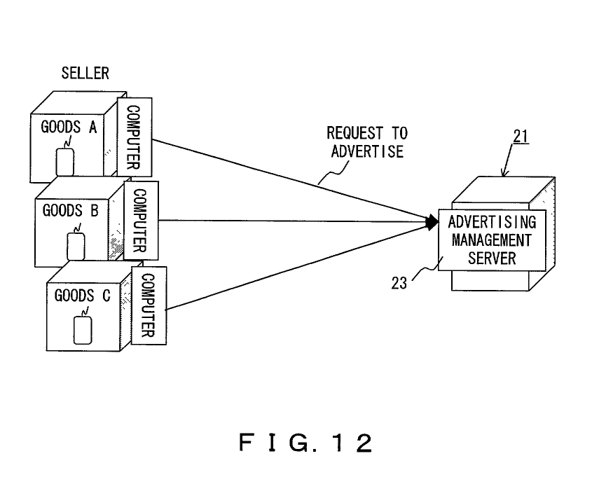

FIG. 12 shows the case in which a seller distributes advertising data from each server to the application service provider ASP server 21, and the advertising data is stored in the advertising management server 23 of the application service provider ASP server 21. In this case, the advertising data is transmitted from the seller/maker server 29 of the seller to the application service provider ASP server 21, and the advertising data is stored in the advertising management server 23 of the application service provider ASP server 21.

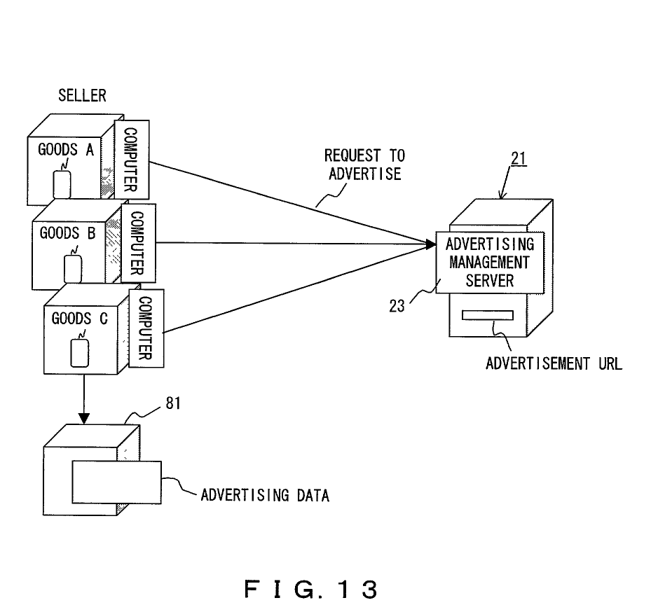

FIG. 13 shows the case in which advertising data is stored in an external advertisement management server 81 provided separate from the advertising management server 23 managed by the application service provider ASP server 21. In this case, for example, a seller stores advertising data in the external advertisement management server 81 managed by the seller, requests the application service provider ASP server 21 to advertise goods, and distributes the URL of the Web site storing advertising data. The advertising management server 23 of the application service provider ASP server 21 stores the URL of the Web site of an external advertisement management server as the advertising data of the advertising management information 50.

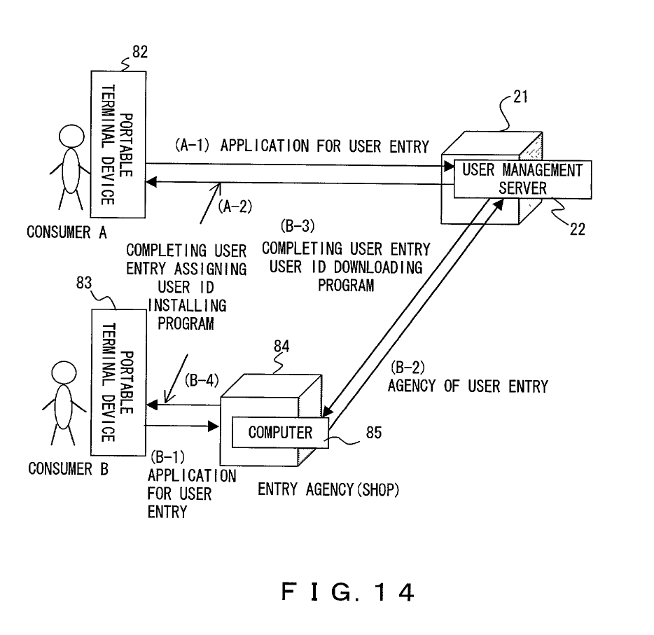

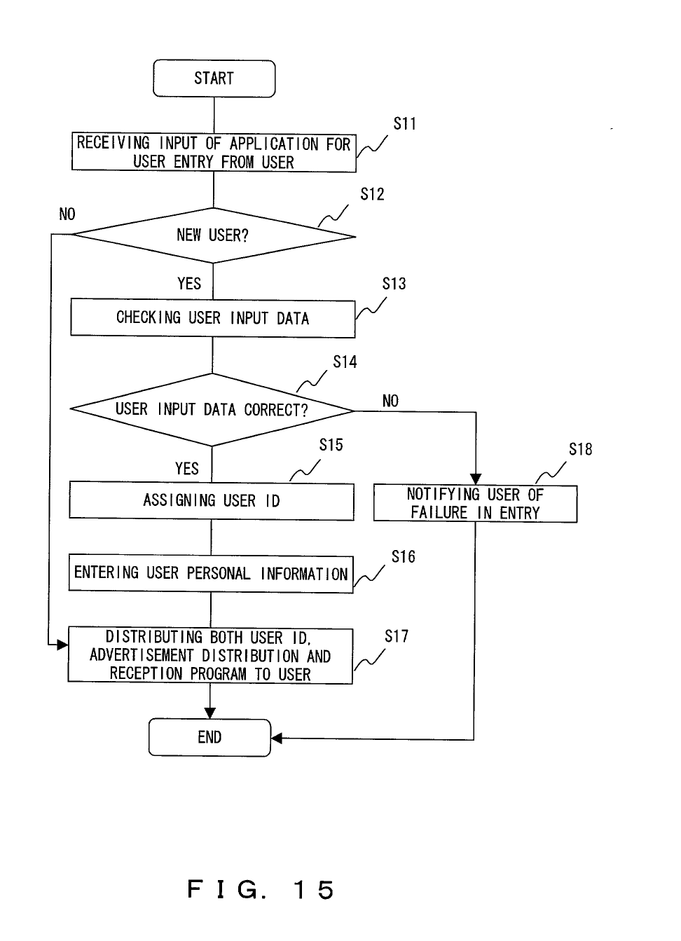

The process of a consumer gaining a user entry in the application service provider ASP server 21 is described below by referring to the explanatory view shown in FIG. 14 and the flowchart shown in FIG. 15.

FIG. 14 shows the procedure of gaining a user entry in the application service provider ASP server 21. FIG. 15 is a flowchart of the process of gaining a user entry in the user management server 22 in the procedure.

First, the consumer A applies to the application service provider ASP server 21 for a user entry through a portable terminal device 82.

Upon receipt of an input of an application for a user entry (S11 shown in FIG. 15), the user management server 22 determined whether or not the user is a new user (S12).

If the user is new, the data input by the user is checked (S13), and it is determined whether or not the input data of the user is correct, that is, whether or not the personal information required for a user entry has been completely input (S14). If the personal information has been normally input (YES in S14), then a user ID is assigned (S15). Then, the input personal information is associated with the user ID and entered as the user personal information 40 (S16). When the user entry is completed, the user ID and the advertisement distribution and reception program are distributed to the user (S17).

If it is determined in step S14 that the input data is not correct (NO in S14), then control is passed to step S18, and the user is notified of the failure in entry.

The above mentioned user entry procedure is described below by referring to FIG. 14. The consumer A applies to the application service provider ASP server 21 from the portable terminal device 82 of the consumer for a user entry (A-1 shown in FIG. 14). If the personal information is input and the user entry has been normally completed, then a user ID is assigned, and the advertisement distribution and reception program is downloaded into the portable terminal device 82 (A-2 shown in 14).

The user entry can be performed not only in the method of a consumer directly performing it through the application service provider ASP server 21, but also by a shop functioning as an entry agency 84 performing a user entry so that a consumer can gain a user entry in the shop, etc.

In this case, as shown in FIG. 14, the consumer B uses a portable terminal device 83 in the entry agency 84 to apply for a user entry according to a wireless signal, etc. through computer 85 of the entry agency 84 (B-1 shown in FIG. 14). Upon receipt of the personal information about the consumer B, the computer 85 transmits the personal information to the application service provider ASP server 21 to perform the user entry for the consumer (B-2 shown in FIG. 14).

When the user entry is completed, the user ID and the advertisement distribution and reception program are downloaded from the application service provider ASP server 21 (B-3 shown in FIG. 14). The computer 85 transmits the user ID and the advertisement distribution and reception program to the portable terminal device 83 and installs it (B-4 shown in FIG. 14).

In the above mentioned process, the user entry procedure of the consumer is completed in the application service provider ASP server 21.

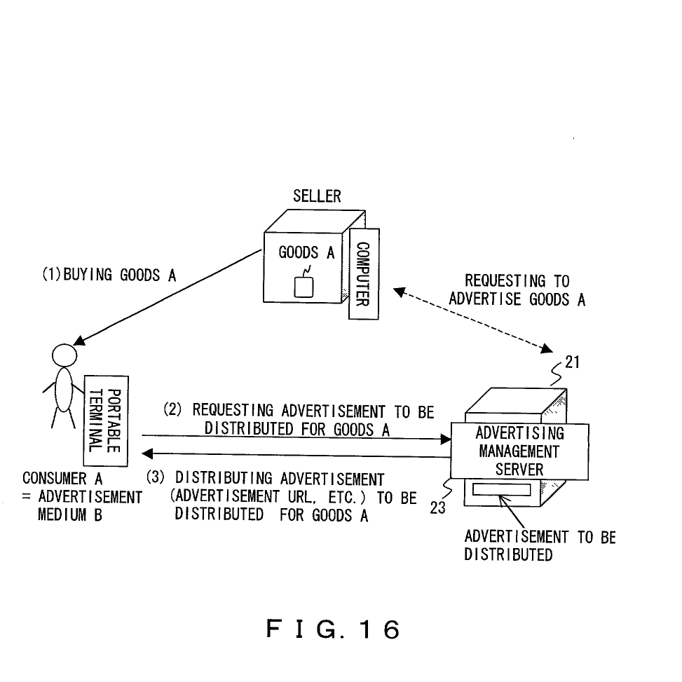

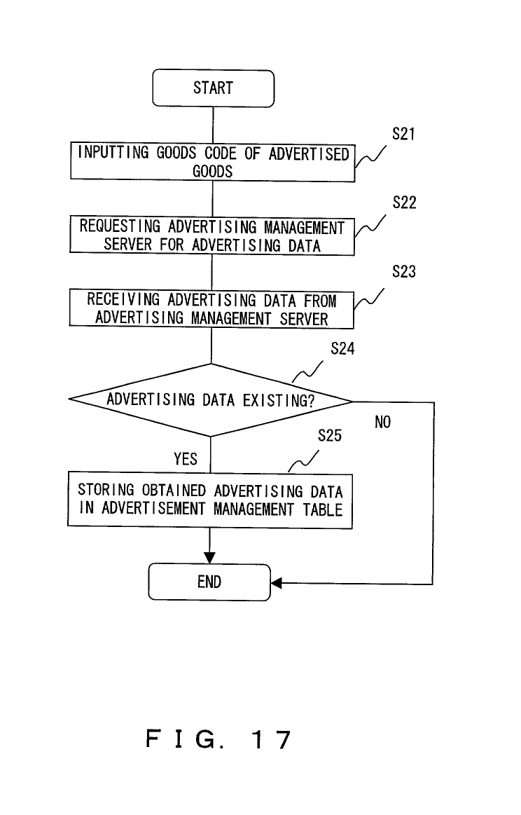

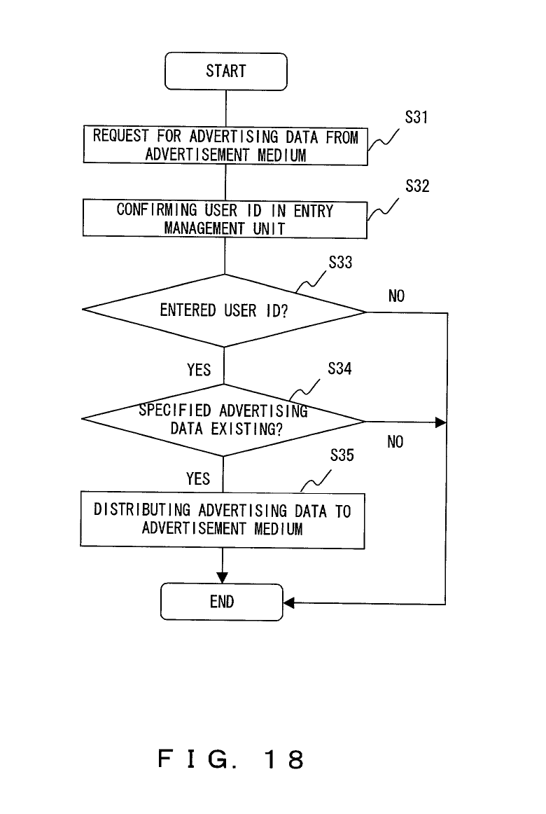

The procedure of obtaining the advertising data of goods when a consumer buys them is described below by referring to the explanatory view shown in FIG. 16 and the flowcharts shown in FIGS. 17 and 18.

In FIG. 16, when the consumer buys goods from a seller ((1) shown in FIG. 16), he or she input the goods code of the obtained goods A and requests the application service provider ASP server 21 to transmit the advertising data to be distributed for the goods A ((2) shown in FIG. 16).

The advertising management server 23 of the application service provider ASP server 21 distributes the advertising data containing the URL of the Web site on which the advertising data of the corresponding goods is displayed to the portable terminal device of the consumer A ((3) shown in FIG. 16). As the advertising data other than the URL, for example, the type, color, etc. of the goods are distributed.

The process of obtaining the advertising data performed by the portable terminal device 26 of an advertisement medium (consumer who bought the goods), and the distributing process by the advertising management server 23 are described below by referring to FIGS. 17 and 18.

The consumer who requests to obtain the advertising data of the purchased goods inputs the goods code from the input unit of the portable terminal device 26 of an advertisement medium (S21 shown in FIG. 17). Then, the consumer sends the goods code and requests the advertising management server 23 of the application service provider ASP server 21 to transmit the advertising data to be distributed (S22 shown in FIG. 17).

Upon receipt of the transmission request from the advertisement medium for the advertising data to be distributed (S31 shown in FIG. 18), the advertising management server 23 inquires of the entry management unit 41 of the user management server 22 whether or not the person requesting to transmit the advertising data to be distributed has gained his or her user entry (S32 shown in FIG. 18). Then it determines whether or not the user ID of the user requesting the distribution matches the user ID entered in the user management server 22 (S33 shown in FIG. 18). If the user IDs match each other, and the user is authenticated (YES in S33), it is checked whether or not the advertising data of the specified goods code has been stored in the storage device 55 (S34 shown in FIG. 18). When there is the advertising data of the specified goods (YES in S34), the advertising data is transmitted to the advertisement medium (consumer who bought the goods) who has issued the transmission request (S35 shown in FIG. 18).

Upon receipt of the response data from the advertising management server 23 (S23 shown in FIG. 17), the portable terminal device 26 of an advertisement medium determines whether or not there is the address in the response data (S24 shown in FIG. 17). If there is the response data (YES in S24), then the obtained advertising data is stored in the advertisement management table.

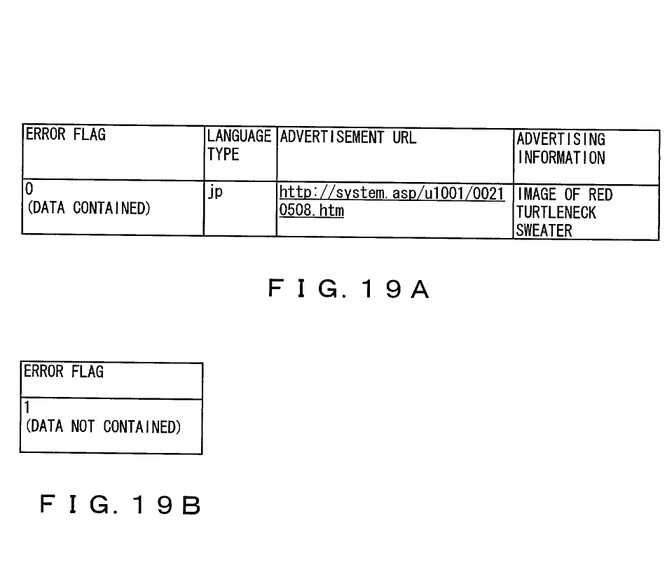

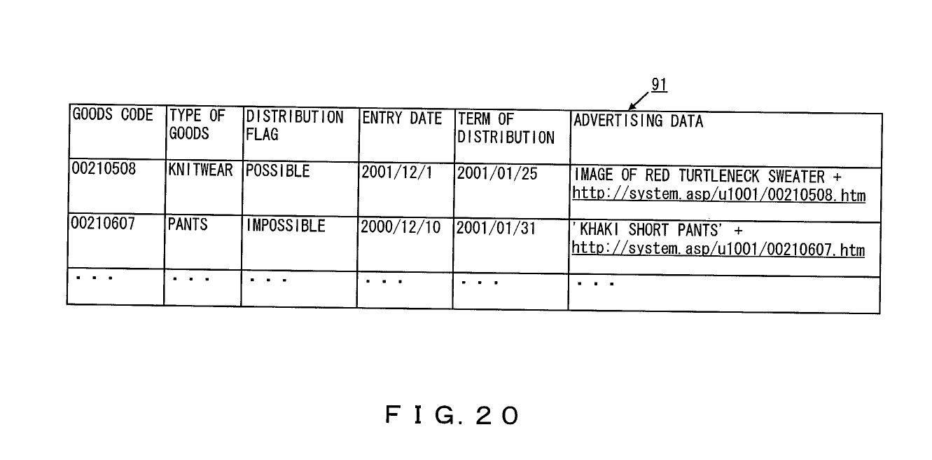

FIG. 19 shows an example of the response data transmitted from the advertising management server 23 in response to the request to transmit the advertising data to be distributed. FIG. 20 shows an example of the advertisement management table of the portable terminal device 26 of an advertisement medium.

Upon receipt of the request to transmit the advertising data from the portable terminal device 26 of an advertisement medium, the advertising management server 23 generates and transmits the response data as shown in FIG. 19A when there is the advertising data of the specified goods.

The response data in this case is formed by an error flag indicating whether or not advertising data exists (0 when advertising data exists, and 1 when no advertising data exists), the URL of the Web site on which the advertising data is provided, and advertising information indicating the contents of the advertisement (for example, an image of a red turtleneck sweater). If no advertising data exists, the above mentioned error flag is set to 1 as shown in FIG. 19B, and the response data is transmitted with no advertising data contained.

FIG. 20 shows an example of an advertisement management table 91 generated by the portable terminal device 26 of an advertisement medium.

In the advertisement management table 91, a goods code, the type of goods, a distribution flag indicating whether or not the advertising data can be distributed when a distribution request is received, the term of distribution, and the URL of the Web site on which the advertising data exists are set.

When the term of distribution is set in the advertisement management table 91, the distribution flag is set as ‘impossible’ and the advertising data cannot be distributed when the term of the distribution expires. Otherwise, when the time advertising data to be distributed only on the day is downloaded into the portable terminal device 26 of an advertisement medium, the data can be automatically deleted without the advertisement medium intending to delete the advertisement by adding the function of automatically deleting the advertising data in a predetermined time.

When a request to distribute advertising data is received from the portable terminal device 27 of a consumer, the portable terminal device 26 of an advertisement medium converts the advertising data having the distribution flag ‘possible’ in the advertisement management table 91 into a wireless signal, and transmits the signal.

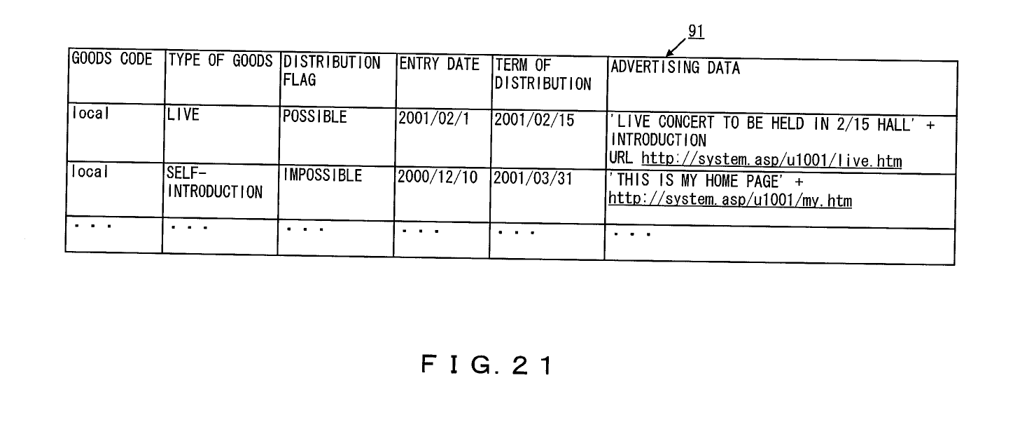

FIG. 21 shows the advertisement management table for use in distributing a local advertisement of an advertisement medium, not the advertising data of the goods the advertisement medium has on or with him or her.

FIG. 21 shows an example of the URL of the home page of a distributor, and the URL through which the information about the live data to be advertised by the distributor. Upon receipt of a request to distribute the advertising data, the portable terminal device 26 of an advertisement medium transmits the information to be personally advertised together with the advertising data, thereby optionally distributing the information.

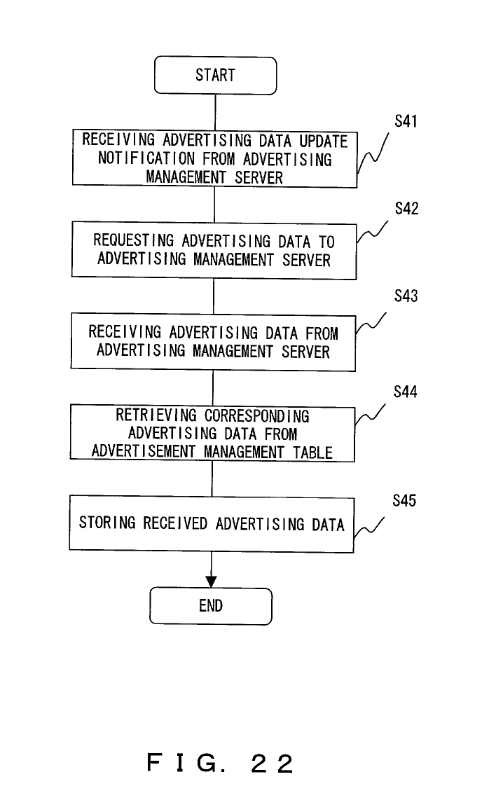

FIG. 22 is a flowchart of the advertising data updating process in the portable terminal device 26 of an advertisement medium.

In the advertising management server 23, when an advertisement is newly updated, the advertisement management unit 51 inquires of the user management server 22 the advertisement medium who has entered the updated advertising data, and notifies the corresponding advertisement medium of the update of the advertising data. Described below is the advertising data updating process in the portable terminal device 26 of an advertisement medium.

Upon receipt of the advertising data update notification from the advertising management server 23 (S41 shown in FIG. 22), the portable terminal device 26 of an advertisement medium requests the advertising management server 23 to distribute the advertising data (S42). When the advertising data is received from the advertising management server 23 (S43), the corresponding advertising data is retrieved from the advertisement management table 91 (S44), and the corresponding advertising data is updated (S45).

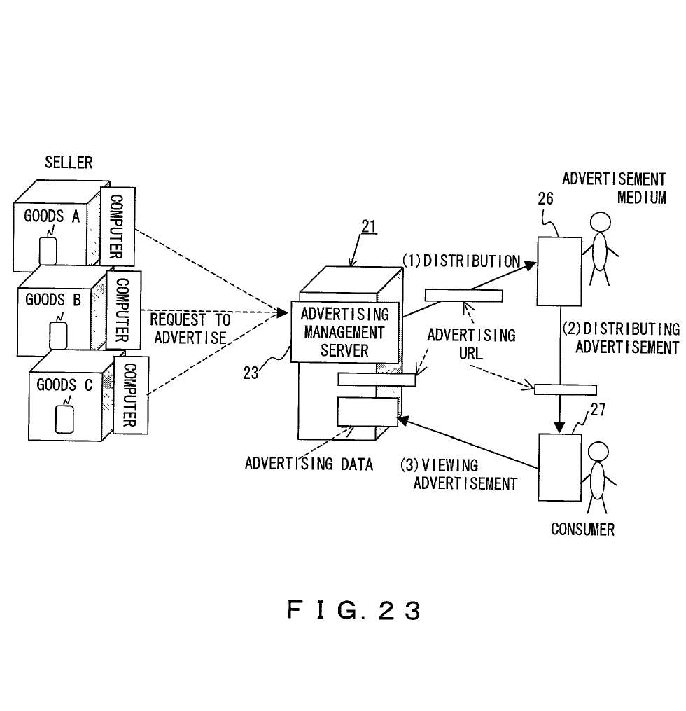

The procedure of viewing the advertisement of the goods found on or with a person in the street, for example, clothes, a bag, sundry goods, etc. is described below by referring to FIG. 23.

The advertisement URL of the goods an advertisement medium has on or with him or her is distributed in advance to the portable terminal device 26 of an advertisement medium ((1) shown in FIG. 23).

If the consumer inputs a keyword, etc. of the goods whose advertisement is to be obtained using the portable terminal device 27 of a consumer, and transmits a request to distribute the advertising data using a wireless signal, then an advertisement medium in the reception area of the wireless signal distributes using a wireless signal the advertisement corresponding to the transmitted keyword in the advertising data entered in the portable terminal device 26 of an advertisement medium ((2) shown in FIG. 23). The consumer selects the advertisement URL of the target goods by referring to the information, etc. indicating the contents of the goods in the advertising data transmitted from the advertisement medium, and views the advertisement according to the URL ((3) shown in FIG. 23).

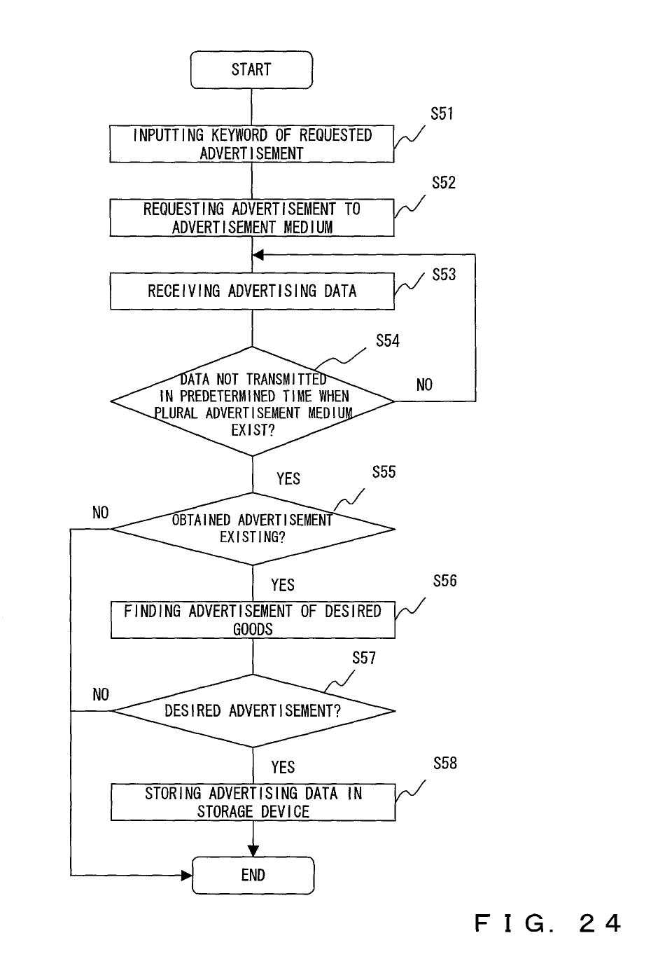

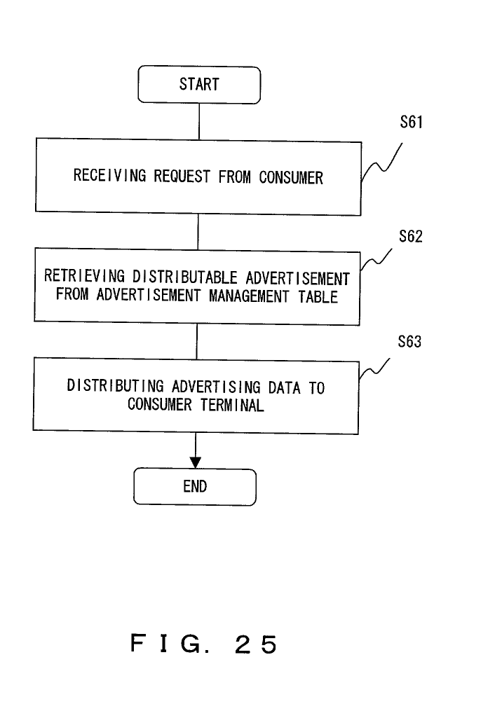

The process of requesting the transmission of advertising data in the portable terminal device 27 of a consumer, and the process of distributing advertising data in the portable terminal device 26 of an advertisement medium are described below by referring to the flowcharts shown in FIGS. 24 and 25.

When a consumer finds any goods a person has on or with him or her in the street, the consumer inputs the type, color, etc. of the goods as a keyword into the portable terminal device 27 of a consumer (S51 shown in FIG. 24). Then, a request to transmit advertising data is transmitted using a wireless signal (S52 shown in FIG. 24).

Upon receipt of the request to transmit the advertising data from the portable terminal device 27 of a consumer (S61 shown in FIG. 25), the portable terminal device 26 of an advertisement medium retrieves an advertisement which can be distributed from the advertisement management table 91 (S62 shown in FIG. 25). Furthermore, the retrieved advertising data is distributed to the portable terminal device 27 of a consumer using a wireless signal (S63 shown in FIG. 25).

The portable terminal device 27 of a consumer receives the advertising data transmitted from the portable terminal device 26 of an advertisement medium by wireless (S54 shown in FIG. 24). When data is transmitted from a plurality of portable terminal devices 26 of advertisement medium, it is confirmed whether or not data is transmitted in a predetermined time. If no data is transmitted, then all data has been completely received (S54 shown in FIG. 24). When all data has been completely received from the portable terminal device 26 of an advertisement medium (YES in S54), it is determined whether or not the received data contains advertising data (S55 shown in FIG. 24). If the received data contains advertising data (YES in S55), then the Web site specified by the URL of the advertising data is accessed to find a desired advertisement (S56 shown in FIG. 24). The consumer determines whether or not there is an advertisement of goods interesting the consumer (S57). If a desired advertisement is found (YES in S57), then the advertising data (in this example, the information about the goods) is downloaded into the storage device 35 of the portable terminal device 27 of a consumer (S58 shown in FIG. 24).

In the above mentioned process, the consumer can easily obtain the advertising data of the goods a person has on or with him or her in the street using the portable terminal device 27 of a consumer such as a portable telephone, etc. of the consumer.

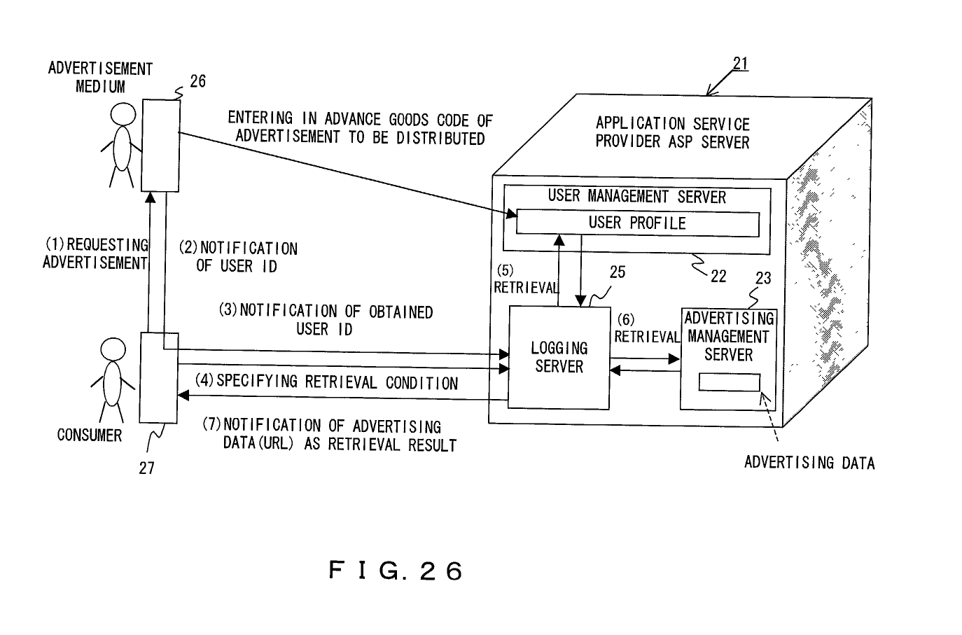

FIG. 26 shows the case in which advertising data is retrieved based on the user ID of an advertisement medium and the retrieval condition specified by a consumer, and the retrieved advertising data is transmitted to the consumer.

In this case, the procedure of the consumer obtaining the advertisement URL (the URL of the Web site on which the advertising data is provided) from the portable terminal device 26 of an advertisement medium is the same as the procedure shown in FIG. 23, the detailed explanation of the procedure is omitted here.

When a consumer requests an advertisement ((1) shown in FIG. 26), and receives an advertisement URL and the user ID of an advertisement medium from the portable terminal device 26 of an advertisement medium using a wireless signal ((2) shown in FIG. 26), the consumer notifies the logging server 25 of the received user ID of the advertisement medium ((3) shown in FIG. 26). Furthermore, the consumer specifies the retrieval condition, for example, the type, color, etc. of the goods ((4) shown in FIG. 26).

The logging server 25 specifies the user ID of the advertisement medium obtained from the portable terminal device 27 as a retrieval key, and requests the application service provider ASP server 21 to retrieve user personal information ((5) shown in FIG. 26). When a goods code entered as associated with the corresponding user ID is obtained, the advertising management server 23 is requested to retrieve the advertising data of the goods which has the goods code and satisfies the specified retrieval condition ((6) shown in FIG. 26). The logging server 25 notifies the consumer of the advertisement URL retrieved by the advertising management server 23 ((7) shown in FIG. 26).

The consumer accesses the Web site using the advertisement URL, and views the advertising data of the desired goods.

In the above mentioned processes, the advertisement of the desired goods of the consumer can be viewed from the application service provider ASP server 21 according to the user ID of the advertisement medium who distributes the advertising data in response to an advertisement distribution request of the consumer, and the retrieval condition such as the type, color, etc. of the goods specified by the consumer.

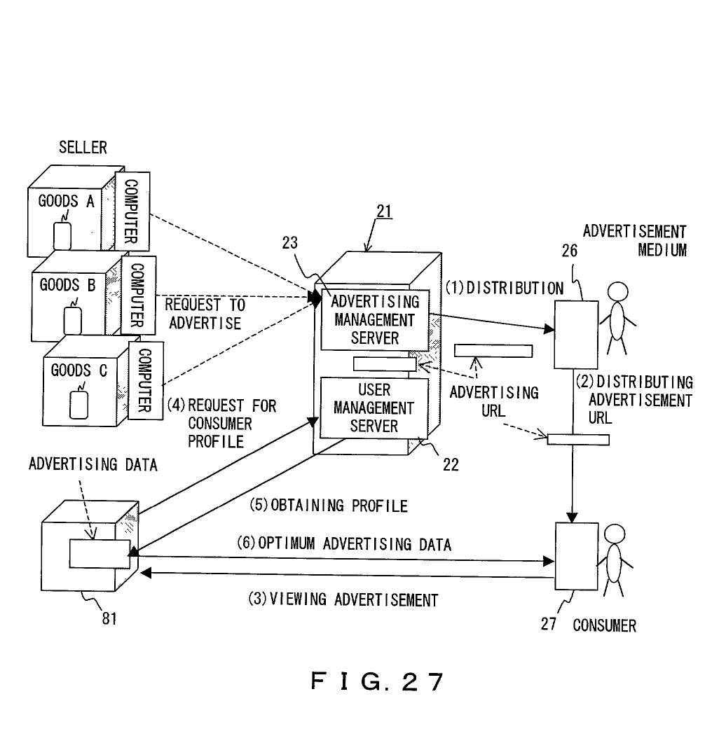

FIG. 27 shows the case in which the optimum advertising data is transmitted to a consumer based on the profile of the consumer.

Upon receipt of the advertisement URL indicating the Web site on which the advertising data exists from the portable terminal device 26 of an advertisement medium ((2) shown in FIG. 27), the portable terminal device 27 of a consumer transmits the advertisement URL transmitted from the advertisement medium, and the user parameter containing the goods code, the user ID of the advertisement medium, and the user ID of the consumer to the external advertisement management server 81 to request to view the advertisement ((3) shown in FIG. 27).

The external advertisement management server 81 transmits the received consumer ID to the user management server 22 of the application service provider ASP server 21, and requests the profile of the corresponding consumer ((4) shown in FIG. 27).

The user management server 22 retrieves the user personal information 40 using the consumer ID received from the external advertisement management server 81, and obtains the profile such as the age, sex, etc. of the corresponding user. The profile is transmitted to the external advertisement management server 81, and the external advertisement management server 81 obtains the profile of the consumer ((5) shown in FIG. 27).

The external advertisement management server 81 retrieves the advertising data of the goods which the consumer requested to view using the obtained profile and the goods code of the user parameter as the key, selects the advertising data matching the consumer profile from the data, and transmits one or more pieces of advertising data to the portable terminal device 27 of a consumer ((6) shown in FIG. 27).

As described above, although there are a number of advertisement mediums around the consumer when the consumer requests to transmit the advertising data, the advertising data of the goods probably most interesting the consumer and matching the profile of the consumer can be provided for the consumer.

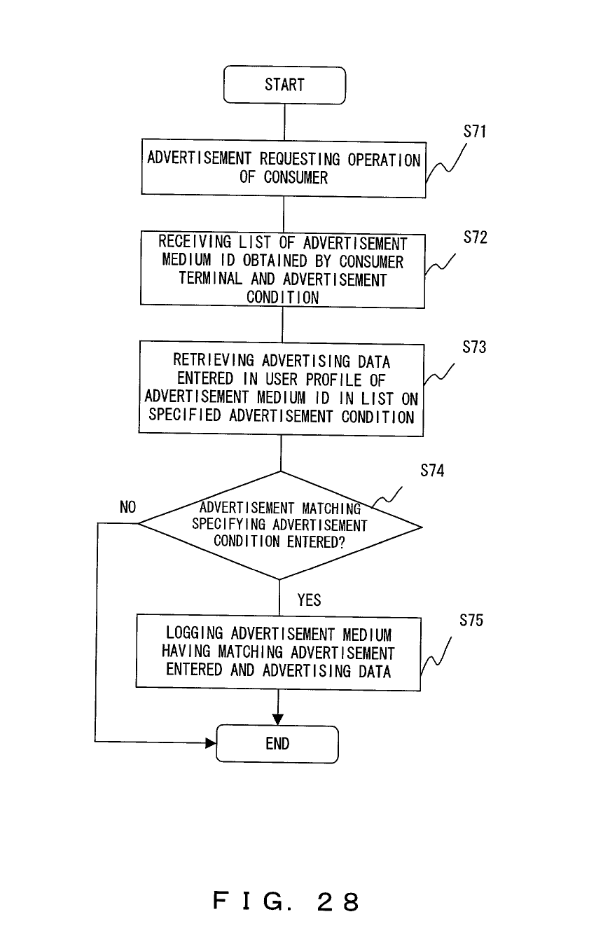

The process of retrieving the advertising data based on the user ID of the above mentioned advertisement medium and the retrieval condition specified by the consumer is described below by referring to the flowchart shown in FIG. 28.

The portable terminal device 27 of a consumer requests to transmit the advertising data, and obtains the user ID of the advertisement medium and the advertising data from the advertisement medium (S71 shown in FIG. 28).

The logging server 25 receives the user ID of the advertisement medium and the advertisement condition (retrieval condition such as the type, color, etc. of the goods) specified by the consumer from the portable terminal device 27 of a consumer (S72), and retrieves the advertising data entered in the user profile (user personal information) corresponding to the user ID of the advertisement medium based on the specified advertisement condition (S73). Then, it determines whether or not the advertising data matching the specified advertisement condition has been entered as the advertising data to be distributed from the specified advertisement medium (S74).

If the advertising data matching the advertisement condition specified by the consumer has been entered (YES in S74), then the corresponding advertisement medium and the advertising data are logged (S75).

In the above mentioned process, the advertisement medium who has distributed the advertising data matching the condition specified by the consumer is designated, and the user ID of the advertisement medium and the user ID of the consumer who received the advertising data from the advertisement medium can be recorded in the logging server 25.

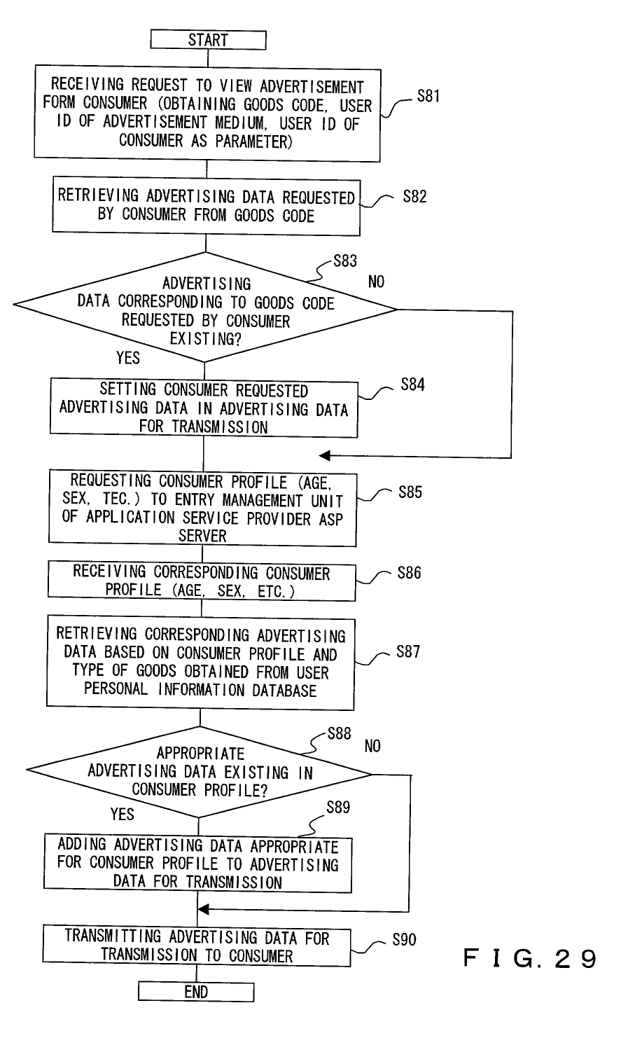

The process of the advertising management server 23 in the application service provider ASP server 21 or the external advertisement management server 81 transmitting the advertising data matching the profile of the consumer to the consumer is described below by referring to the flowchart shown in FIG. 29.

A request to view an advertisement is received from the portable terminal device 27 of a consumer (S81 shown in FIG. 29).

As the transmission data of a request to view an advertisement, the advertisement URL transmitted from the advertisement medium, and a user parameter containing a goods code, the user ID of an advertisement medium, the user ID of a consumer, etc. are transmitted. Based on the received goods code, the consumer requested advertising data is retrieved (S82). Then, it is determined whether or not the advertising data corresponding to the consumer requested goods code has been entered in the storage device 55 of the advertising management server 23 (S83). If the advertising data has been entered (YES in S83), then the consumer requested advertising data is set as advertising data for transmission (S84).

After step S84, or when it is determined in step S83 that there is no advertising data corresponding to the consumer requested goods code (NO in S83), then the entry management unit 41 of the user management server 22 is notified of the user ID of the consumer and requested to transmit the profile (age, sex, etc.) of the consumer (S85).

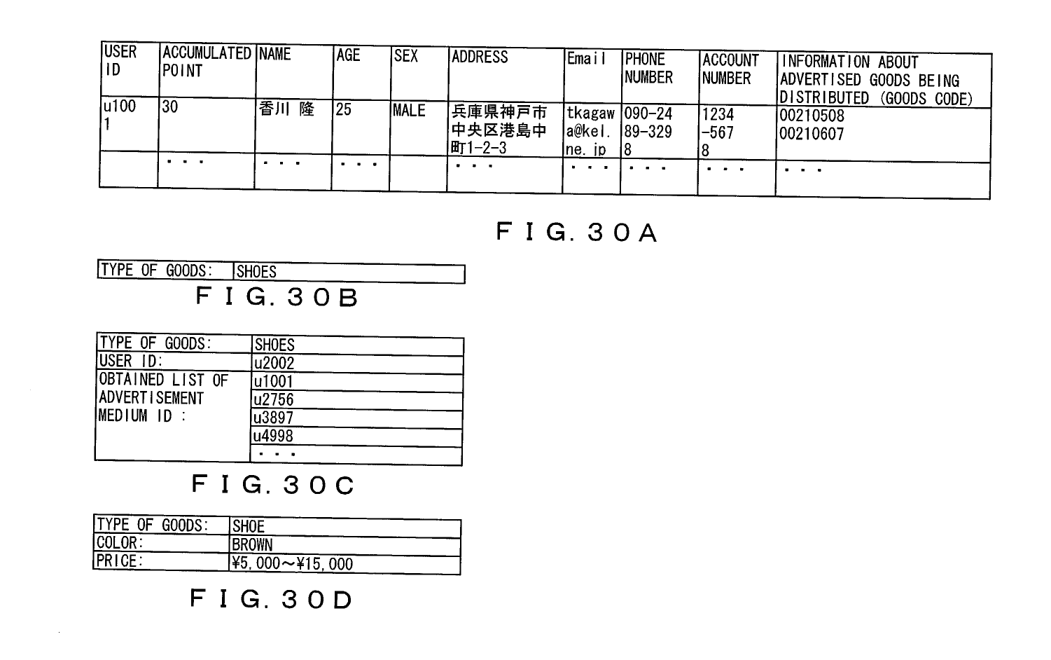

FIG. 30A shows an example of a user profile managed by the user management server 22. When the user ID of the consumer is specified, the user management server 22 retrieves the user personal information 40 using the user ID, obtains the information such as the age, sex, etc. of the corresponding consumer, and transmits the consumer profile to the advertising management server 23.

Upon receipt of the consumer profile from the user management server 22 (S86), the advertising management server 23 retrieves the corresponding advertising data based on the received consumer profile and the type of the goods specified by the goods code (S87). That is, the advertisement of the goods of the type interesting the consumer and matching the profile of the consumer is retrieved.

After the retrieval, it is determined whether or not the advertisement medium having the profile similar to the profile of the consumer has the advertising data of the same type of goods (S88).

If there is the advertising data matching the consumer profile (YES in S88), then the advertising data obtained in the retrieval is added as the advertising data for transmission (S89). Then, the advertising data for transmission is transmitted to the consumer requesting to view the advertising data for transmission (S90).

FIGS. 30B and 30C show that advertising data is to be retrieved using the user IDs of a plurality of advertisement medium, the user ID of a consumer, and the specified goods type ‘shoes’ as the retrieval condition when the consumer specifies the goods type ‘shoes’ as the retrieval condition of an advertisement.

FIG. 30D shows the retrieval condition when the goods type ‘shoes’, the color ‘brown’, and the price ‘5,000 through 15,000 yen’ are specified.

In the above mentioned process, the consumer can obtain the information (for example, a goods code and a user ID) from the advertisement medium, and the advertising data of the goods matching the profile of the consumer. In this case, although there is no stock of the goods of the goods code obtained from the advertisement medium, the advertising data of other goods similar in type of the goods interesting the consumer and matching the profile of the consumer can be transmitted to the consumer. Therefore, the consumer can obtain the information about desired goods with the operation performed smaller number of times.

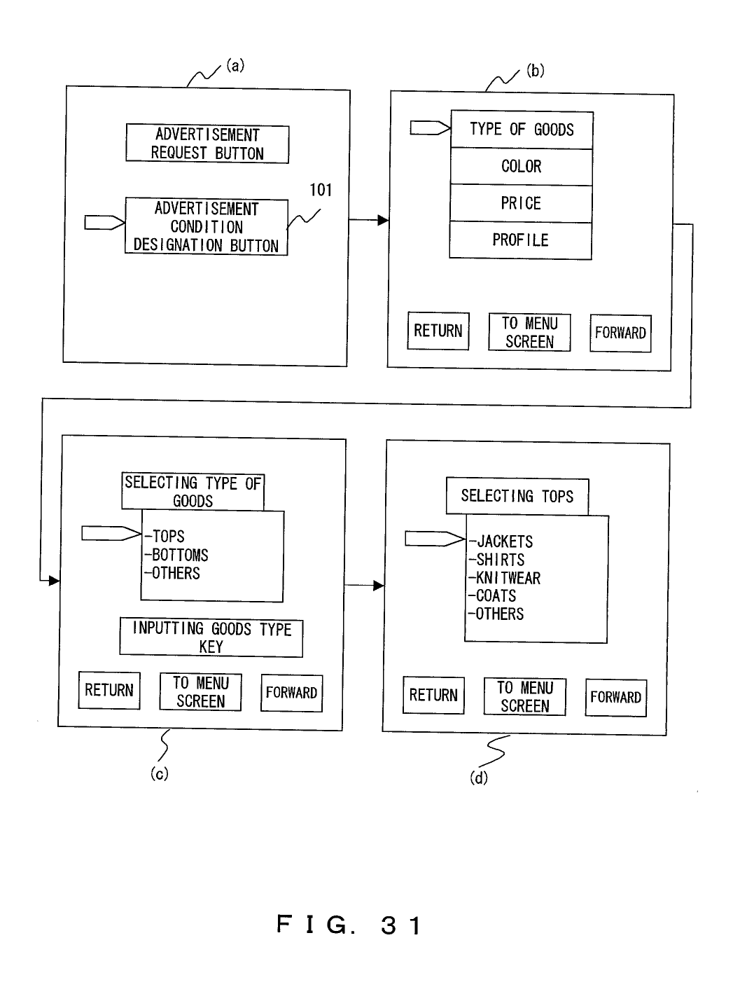

FIG. 31 shows the menu screen on which the retrieval condition is input in the portable terminal device 27 of a consumer.

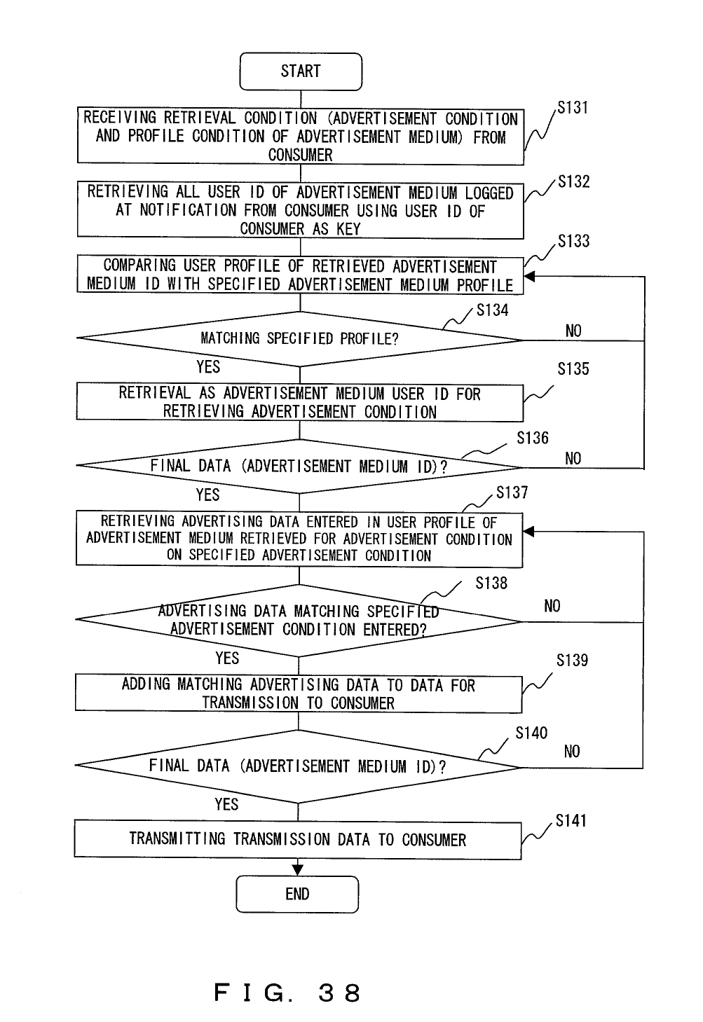

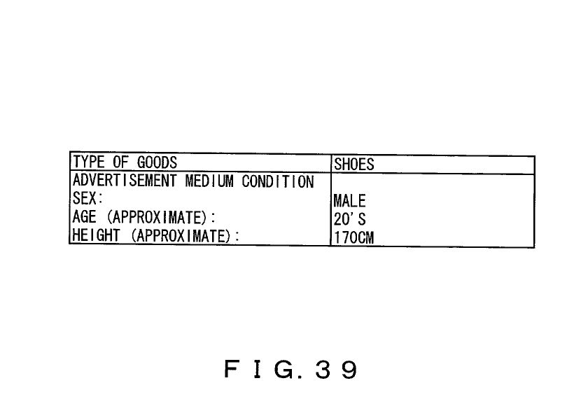

First, an advertisement request button and an advertisement condition designation button 101 are displayed ((a) shown in FIG. 31). When the advertisement condition designation button 101 is operated, a selection menu for the type, color, and price of goods, and a profile (the profile of the advertisement medium described later by referring to FIGS. 38 and 39) is displayed ((b) shown in FIG. 31). When one of the selection item is selected in the selection menu, the following selection menu appears.

For example, when the type of goods is selected, the details ‘tops’, ‘bottoms’, ‘others’, and ‘Input goods type key’ are displayed ((c) shown in 31). If the ‘tops’ is selected on this screen, the selection menu of ‘jackets’, ‘shirts’, ‘knitwear’, ‘coats’, etc. is displayed ((d) shown in FIG. 31).

The consumer can easily input the retrieval condition by sequentially selecting the above mentioned menu displayed on a display unit 39 of the portable terminal device 27 of a consumer.

When the consumer views or purchases the advertisement or the goods according to the information about the goods provided by the advertisement medium, the advertisement medium is given a point as described below.

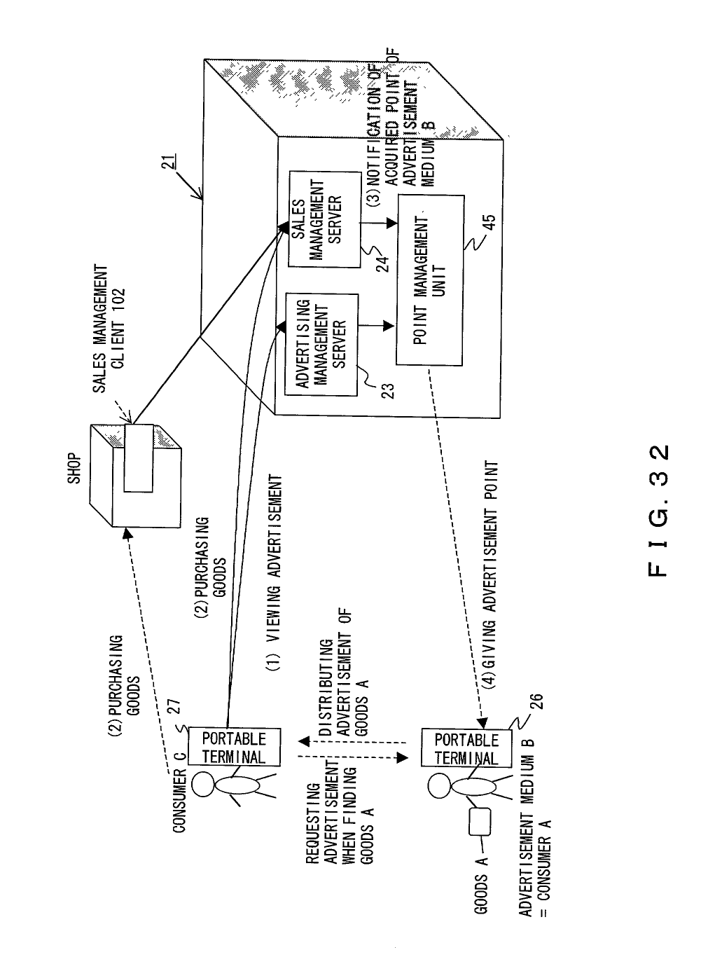

FIG. 32 shows the case in which an advertisement medium is given a point when a consumer views an advertisement.

When a consumer C finds a person having goods A on him or her, and transmits a request to distribute an advertisement by wireless using the portable terminal device 27 of a consumer, advertisement medium in a predetermined wireless area transmit advertising data by wireless signals.

For example, if a consumer C views an advertisement by accessing the advertising management server 23 of the application service provider ASP server 21 using the advertisement URL transmitted from the advertisement medium B ((1) shown in FIG. 32), and purchases the goods using the sales management server 24 or a sales management client 102 ((2) shown in FIG. 32), then the information that the advertisement has been viewed is transmitted from the advertising management server 23 to the sales management server 24, and the information that the goods have been purchased is transmitted to the sales management server 24, or from the sales management client 102 to the sales management server 24. Then, to give a point to the advertisement medium B who distributed the advertising data according to which the consumer viewed the advertisement (or purchased the goods), each acquired point is notified to the point management unit 45 of the user management server 22 ((3) shown in FIG. 32).

The user management server 22 adds an acquired point to the accumulated point of the advertisement medium B, and notifies the portable terminal device 26 of an advertisement medium of the corresponding advertisement medium B that an advertisement point has been acquired ((4) shown in 32).

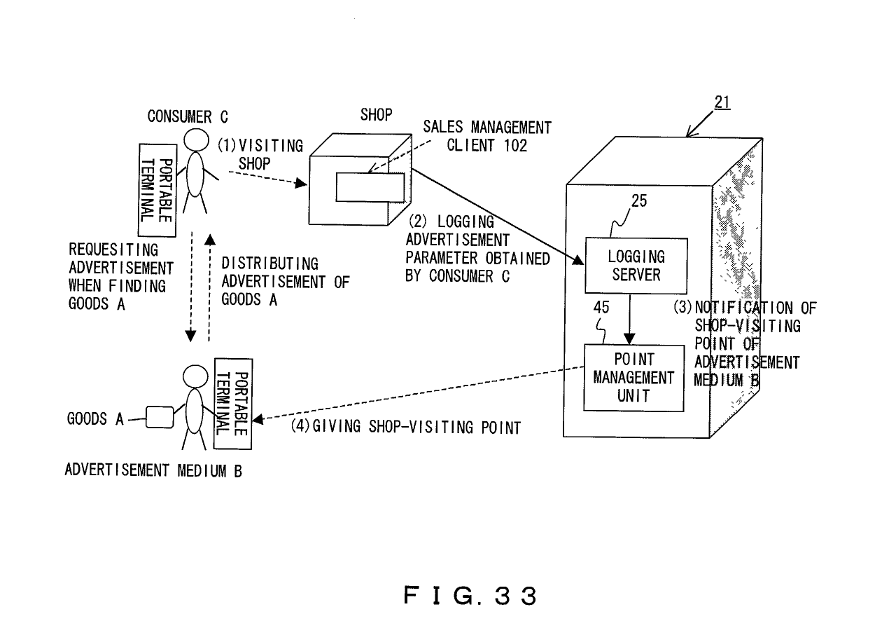

FIG. 33 shows the case in which a point is given to an advertisement medium when a consumer receiving the advertising data distributed by the advertisement medium visits the shop.

This case is basically similar to the case shown in FIG. 32. When the consumer C finds the goods A, obtains the advertising data from the advertisement medium, and visits the shop ((1) shown in FIG. 33, the sales management client 102 obtains an advertisement parameter containing the user ID of the advertisement medium from the consumer C, and transmits the parameter to the logging server 25 ((2) shown in FIG. 33). The logging server 25 notifies the point management unit 45 of the shop-visiting point acquired by the advertisement medium B ((3) shown in FIG. 33), and the point management unit 45 adds the shop-visiting point to the accumulated point of the corresponding advertisement medium. Furthermore, the advertisement medium B is notified that the shop-visiting point has been acquired ((4) shown in FIG. 33).

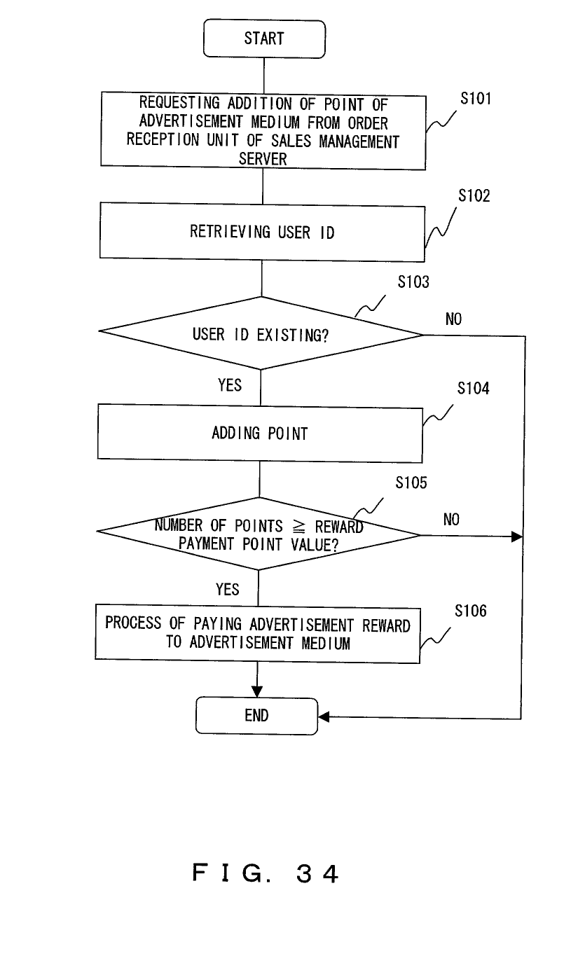

FIG. 34 is a flowchart of the process of giving a point to an advertisement medium in the point management unit 45.

Upon receipt of a request to add a point of an advertisement medium from the sales management server 24 (S101 shown in FIG. 34), the point management unit 45 of the user management server 22 retrieves the user personal information 40 according to the user ID of the advertisement medium (S102), and determines whether or not the user ID corresponding to the user personal information 40 has been entered in the user personal information 40 (S103).

When the user ID of the specified advertisement medium is entered (YES in S103), the acquired point is added to the accumulated point of the advertisement medium (S104). Then, it is determined whether or not the accumulated point value stored in the user personal information 40 has reached the reward value (S105).

If the accumulated point value has reached the reward value (YES in S105), then the advertisement reward is transferred to the account of the corresponding advertisement medium (S106). If the accumulated point value has not reached the reward value yet (NO in S105), then the process terminates.

According to the above mentioned embodiments, an advertisement reward can be obtained depending on the advertising effect of the advertisement medium in various cases described below. Therefore, the consumer who purchased goods is promoted to be willing to provide an advertisement as an advertisement medium, and the provider and the seller of the goods can expect a larger advertising effect with an increasing number of advertisement medium.

(1) An advertisement medium is given an advertisement view point when a consumer first accesses an advertising management server 23 to view goods information according to the advertising data received from the advertisement medium.

(2) The sales management server 24 gives a purchase point to an advertisement medium when a consumer views goods information and purchases the goods according to the advertising information received from the advertisement medium.

(3) If a consumer visits a shop according to the advertisement received from an advertisement medium, the shop confirms whether or not the consumer has visited according to the advertisement provided by the advertisement medium, and the consumer has visited according to the advertisement from the advertisement medium, then a user parameter containing the user information of the advertisement medium, etc. is obtained, and the ID of the advertisement medium is transmitted to the logging server 25 of the application service provider ASP server 21, thereby giving the visiting point to the advertisement medium.

In (1) above, when an electronic transaction is performed outside the application service provider ASP server 21, the advertisement of a maker is a common advertisement. Therefore, unlike the advertisement of a specific shop, the contents of the advertisement refer to the introduction of an available EC (electronic transaction) site, a purchase method, an introduction to related goods, etc. It is difficult to associate between the maker and the shop, and is therefore difficult to appropriately give a sales point. As a result, a point relating to an advertisement of a maker is limited to an advertisement view point only.

In (2) above, when goods are sold in the application service provider ASP server 21, the sales management server 24 can specify a consumer and an advertisement medium, and can manage the profiles. Therefore, if a consumer accesses the sales management server 24 according to advertisement information received from an advertisement medium, then the user parameter is recorded, and a purchase point is given to the consumer when the consumer purchases goods corresponding to the advertising data or purchases goods relating to the goods.

The user management server 22 receives from each management server a notification of an acquired point by viewing the goods information according to the advertising information distributed by an advertisement medium, by purchasing goods, and by visiting a shop, adds the acquired point of the advertisement medium, and manages the accumulated point. When the accumulated point value reaches a predetermined value, an advertising reward is paid to the advertisement medium.

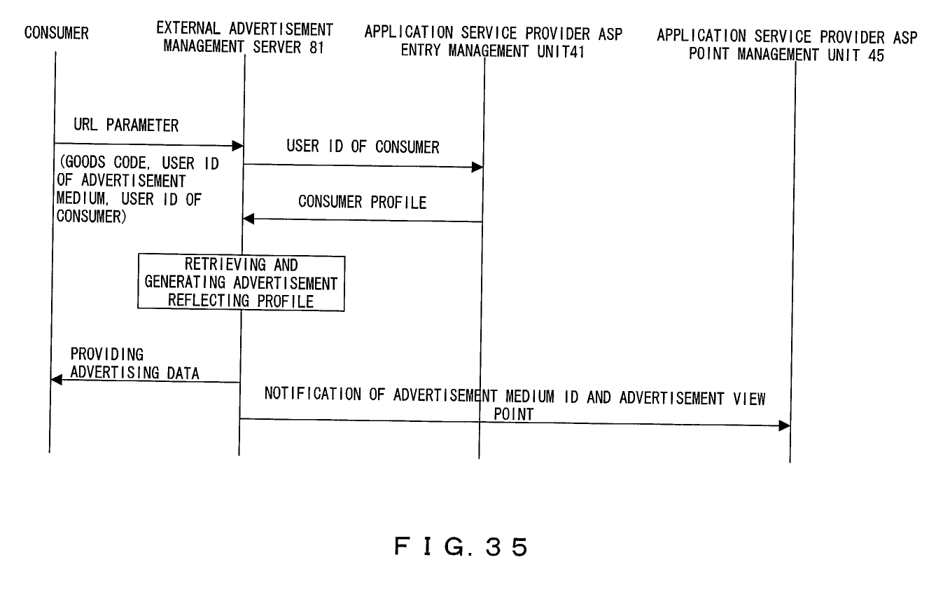

FIG. 35 shows the sequence of providing advertising data for the consumer based on the profile, and giving an advertisement view point to an advertisement medium.

The consumer receives advertising data (containing the user ID of the advertisement medium and a goods code) from the advertisement medium, and transmits a user (URL) parameter containing the user ID of the consumer to the external advertisement management server 81.

The external advertisement management server 81 transmits the user ID of the consumer to the entry management unit 41 of the user management server 22, and obtains the profile of the corresponding consumer. Then, it retrieves the advertising data reflecting the profile of the consumer, and provides the consumer with the advertising data matching the profile of the consumer. Furthermore, the external advertisement management server 81 notifies the point management unit 45 of the user ID of the advertisement medium who has promoted the consumer to view the advertisement and the advertisement view point. Upon receipt of the notification, the point management unit 45 adds the advertisement view point to the accumulated point of the corresponding user stored as the user personal information 40.

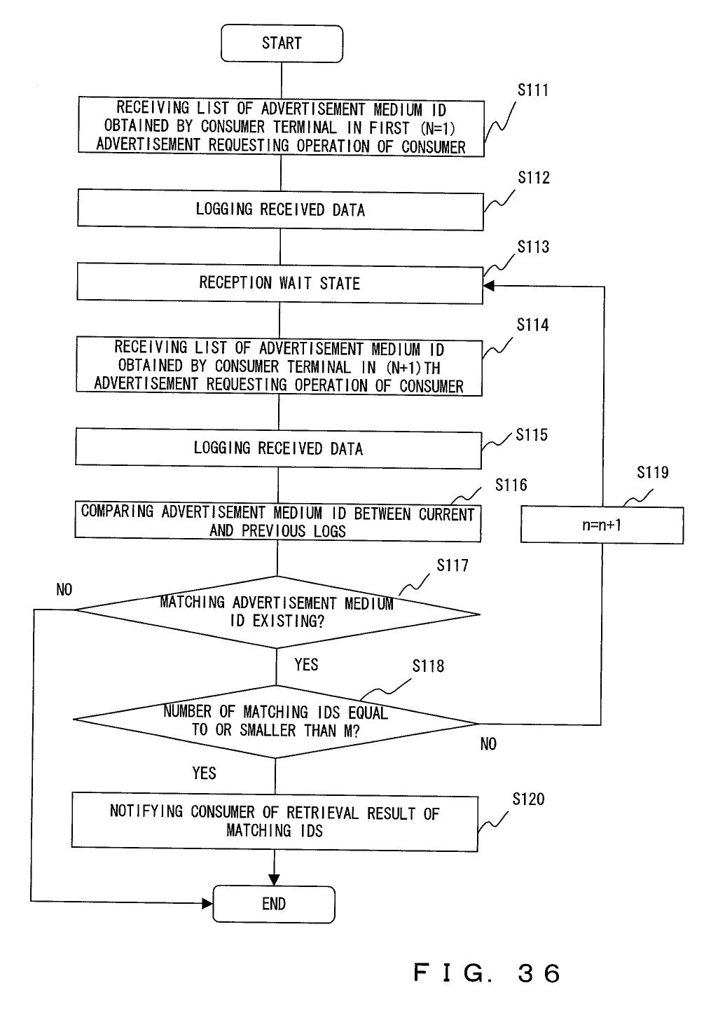

FIG. 36 is a flowchart of the process of limiting the number of advertisement medium in the advertisement providing system according to the second embodiment of the present invention.

The system configuration according to the second embodiment is the same as that according to the first embodiment shown in FIG. 3. The difference is that the advertisement URL, a goods code, etc. are not stored in the portable terminal device 26 of an advertisement medium, and only the user ID of an advertisement medium is transmitted to a consumer when a request to transmit goods information is received from the consumer. Then, after the consumer specifies the retrieval condition such as the user ID of an advertisement medium, the type, color, etc. of the goods the consumer requests to know, the application service provider ASP server 21 transmits the user ID of the advertisement medium, and the corresponding advertising data retrieved based on the retrieval condition specified by the consumer.

Furthermore, the consumer performs plural times the advertisement requesting operation when a target advertisement medium is in a predetermined wireless area, thereby generating a list of advertisement medium who transmit user IDs, and limiting the number of advertisement medium.

When a target person, that is, a person who has on him or her goods interesting the consumer, is in a wireless communications area, the consumer performs an advertisement medium requesting operation, and receives the user ID of the advertisement medium. In this case, if there are a large number of advertisement medium in the wireless communications area, a large number of user IDs of advertisement medium can be returned. Or, there can be only one user ID of an advertisement medium returned. In any case, it is not certain that the advertisement medium is the target person. Therefore, the user ID of the obtained advertisement medium is logged, and the consumer performs again a few minutes later the advertisement requesting operation on the condition that a target person is in the wireless communications area. In the street, since there are active movements of people, it is predicted that the configuration of the advertisement medium in the wireless communications area is quite different between the previous and current operations. Therefore, there is the strong possibility that the advertisement medium whose user ID can be obtained every time is the target person. Therefore, the user ID obtained in the current logging operation is compared with the user ID obtained in the previous logging operation, and the advertisement medium having the matching user IDs is counted. By limiting the number of advertisement medium, a desired advertisement can be obtained.

The process of limiting the number of advertisement medium according to the second embodiment of the present invention is described below by referring to the flowchart shown in FIG. 36.

The logging server 25 of the application service provider ASP server 21 receives a list of the user IDs of the advertisement medium in the wireless area obtained by the portable terminal device 27 of a consumer when the consumer first performs the advertisement requesting operation (S111 shown in FIG. 36). The received list of user IDs of the advertisement medium is recorded (S112), and then enters a wait state for reception (S113).

For example, the consumer moves with the movement of a target advertisement medium, the consumer performs the (n+1)th advertisement requesting operation, and receives a list of IDs of the advertisement medium transmitted from the portable terminal device 27 of a consumer. The received list of the user IDs of the advertisement medium is logged (S115). Then, the user IDs of the advertisement medium are compared between the previous and current logs (S116).

Then, it is determined whether or not the matching user IDs of advertisement medium exist (S117). If the matching user IDs exist (YES in S117), then it is determined whether or not the number of matching IDs is equal to or smaller than m (S118).

If the number of matching IDs is not equal to or smaller than m, that is, excels the predetermined value m (NO in S118), then control is passed to step S119, 1 is added to the value of the counter n, and control is returned to the wait state in step S113.

On the other hand, when the number of matching IDs of the advertisement medium is equal to or smaller than a predetermined value m (YES in S118), the number of target advertisement medium can be limited, thereby notifying the consumer of the retrieval result of the matching user IDs (S120).

According to the second embodiment of the present invention, if there is a number of advertisement medium, or there are only a small number of advertisement medium answering when a consumer sees a person having interesting goods on him or her, and the consumer issues a request to transmit advertising information (goods information) through the portable terminal device 27 of a consumer, and it is not certain that the answering advertisement medium are target advertisement medium, the number of advertisement medium can be limited by performing the advertisement requesting operation plural times. Thus, desired goods information and advertisement can be obtained without fail.

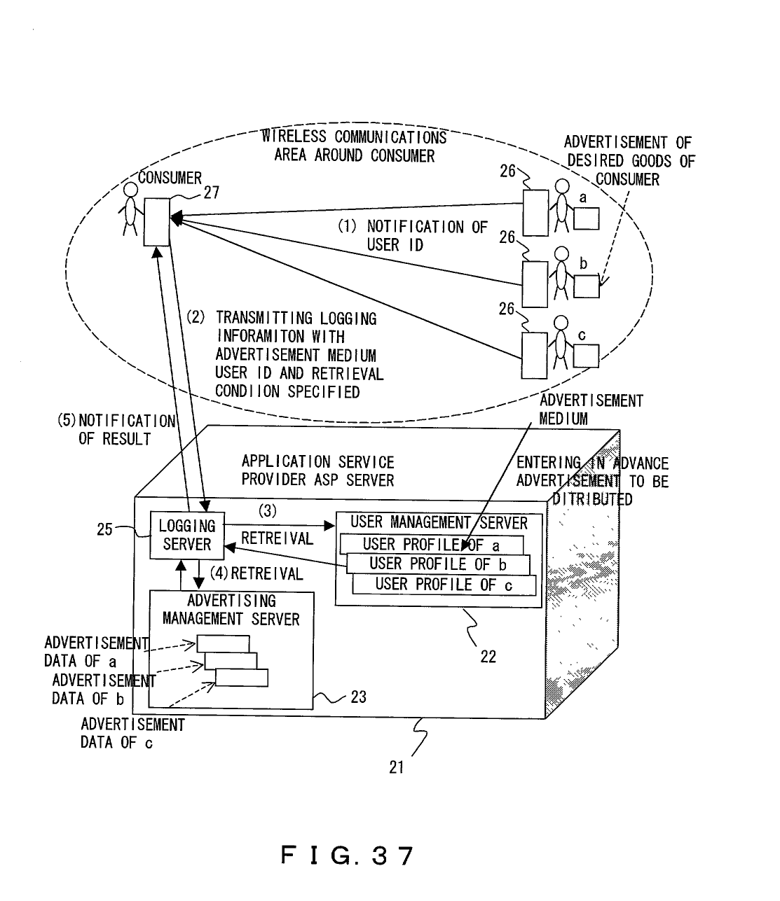

FIG. 37 shows the procedure of viewing an advertisement according to the third embodiment of the present invention.

According to the third embodiment, the advertising data entered by an advertisement medium close to the profile specified in the advertisement medium near the consumer can be distributed to the consumer who has issued a request to view an advertisement by specifying the profile of the advertisement medium having goods b interesting the consumer.

Upon receipt of a request to transmit an advertisement from a consumer, the advertisement medium in the wireless communications area transmits his or her own user ID by a wireless signal ((1) shown in FIG. 37).

The consumer transmits the user ID received from an advertisement medium, and an approximate profile of the advertisement medium having goods on or with him or her which interest the consumer as the retrieval condition to the logging server 25 of the application service provider ASP server 21 ((2) shown in FIG. 37).

The logging server 25 notifies the user management server 22 of the user ID of the advertisement medium transmitted from a consumer, and the approximate profile of a target advertisement medium (an advertisement medium having goods b in this example). The user management server 22 retrieves the user personal information 40 using the user ID as a key, and further retrieves the advertisement medium having a profile closer to the profile specified by the consumer. If the advertisement medium closer to the profile specified by the consumer exists, then the advertising data (advertisement URL) entered in the user personal information 40 of the user is obtained, and notifies the logging server 25 of the data ((3) shown in FIG. 37).

The logging server 25 retrieves the advertising data entered in the advertising management server 23 using the advertisement URL obtained from the user management server 22 as a key ((4) shown in FIG. 37), and notifies the consumer of the retrieval result ((5) shown in FIG. 37).

FIG. 38 is a flowchart of the advertisement distributing process in the logging server 25 according to the third embodiment.

The logging server 25 receives the advertisement condition (the type, color, etc. of the goods an advertisement medium has on or with him or her, and interesting the consumer) and the retrieval condition containing the profile of the advertisement medium from the consumer (S131 shown in FIG. 38).

FIG. 39 shows the retrieval condition containing the profile of the above mentioned advertisement medium. In this example, the advertisement medium having the goods ‘shoes’ interesting the consumer is a male in his 20's, and about 170 cm high is transmitted from the consumer to the application service provider ASP server 21 as a profile of the advertisement medium, and the conditions are used as the retrieval condition for designation of the advertisement medium.

Back in FIG. 38, the logging server 25 retrieves the ID of the advertisement medium notified by the consumer and recorded as a log using the user ID of the consumer as a key, that is, all user IDs of the advertisement medium received in response to the advertisement request of the consumer (S132). Furthermore, the profile specified by the retrieved user ID of the advertisement medium is obtained from the user management server 22, and the obtained profile is compared with the user profile of the target advertisement medium specified by the consumer (S133). Then, it is determined whether or not the user profiles match each other or are similar with each other (S134).

If the profiles match or are similar with each other (YES in S134), then the user ID is retrieved as the user ID of the advertisement medium for retrieval of an advertisement condition (S135).

Then, it is determined whether or not the comparison of the profile of the last advertisement medium recorded in the log has been completed (S136). If the profile of the last advertisement medium has not been compared (NO in S136), then control is returned to step S133, and the user profile of the next advertisement medium recorded in the log is compared with the specified profile.

When the comparison of the profile of the last advertisement medium recorded in the log is completed (YES in S136), the advertising data stored corresponding to the user ID of the advertisement medium retrieved for retrieval of an advertisement condition is retrieved under the advertisement condition specified by the consumer (S137).

Then, it is determined whether or not the advertising data matching or similar with the specified advertisement condition has been entered in the user personal information 40 of an advertisement medium having a matching or similar user profile (S138).

When advertising data matching or similar to a specified condition is entered (YES in S138), the advertising data is added to the transmission data of the consumer (S139).

Next, it is determined whether or not the comparison of the advertising data of the final advertisement medium has been completed, that is, whether or not the advertising data entered in the user personal information 40 for all advertisement medium having matching user profiles has been compared with the retrieval condition specified by the consumer (S140).

If the comparison has not been completed (NO in S140), then control is returned to step S137, and the advertising data entered in the user personal information 40 of the subsequent advertisement medium is retrieved.

On the other hand, if the comparison of the advertising data of all advertisement medium having matching or similar user profiles has been completed (YES in S140), then the transmission data set in the above mentioned process is transmitted to the consumer (S141).

The log information stored in the logging server 25 is deleted when (a) an advertisement satisfying the condition is detected, (b) the maximum data area for storing a log is reserved, the consumer determines to delete, or an older log is automatically deleted, (c) a log start/end command is set in the data when the log information is transmitted from the consumer terminal, and the consumer specifies the start/end of the logging process, etc. The above mentioned methods are the standard of limiting the advertisement retrieval range in the log information.

Furthermore, a user terminal contains a GPS (global positioning system) to retrieve an advertisement by specifying the place of a person having goods desired by the consumer by logging the position in which the user ID of the advertisement medium has been obtained with the time stamp when the user ID of the advertisement medium obtained by an advertisement request is logged, thereby detecting an advertisement with higher precision.

Furthermore, when a user is a foreigner, a receiver can optionally select a language as the function of the advertisement distribution and reception program. When the original data of an advertisement is entered in a plurality of languages, the language for an advertisement is switched. In this case, the advertising data holds the type of language. For example, when an English speaking consumer receives an advertisement in Japanese, and the receiver set the display of an advertisement in English, the advertisement distribution and reception program accesses the advertising management server 23 of the application service provider ASP server 21 to retrieve the corresponding advertisement. When the corresponding advertisement in English is retrieved, it is obtained and the received advertisement of the receiver is switched into an English version.

According to the third embodiment, the number of advertisement medium can be limited by specifying the profile of the advertisement medium having the goods interesting the consumer. Therefore, if it is difficult to specify the target advertisement medium in a large number of advertisement medium answering the request of the consumer to transmit an advertisement, the target advertisement medium providing the advertisement of the goods the consumer is interested in can be correctly selected.

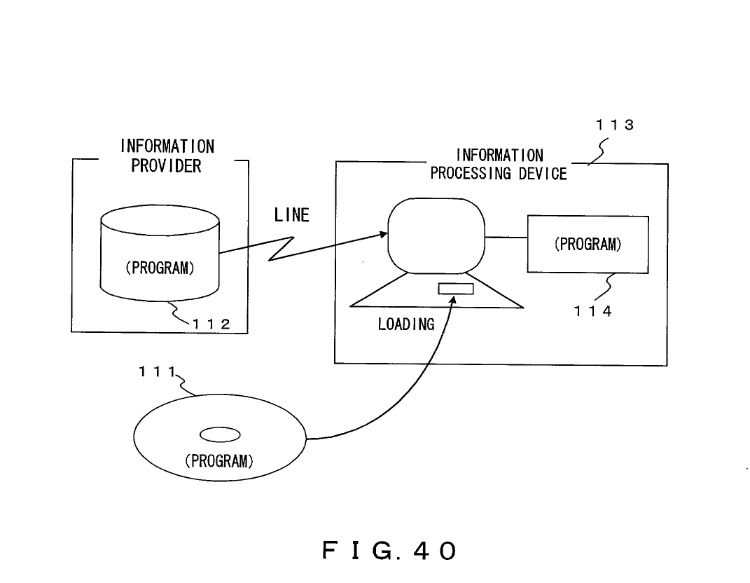

FIG. 40 shows the case in which a program realizing the above mentioned advertisement providing system is stored in CD-ROM, a portable storage medium 111 such as a floppy disk, etc., or a storage device 112 of a program provider, and the program is downloaded into an information processing device 113 such as the application service provider ASP server 21, the portable terminal devices 26 and 27, etc.

When an advertisement providing program is stored in the portable storage medium 111 such as a CD-ROM, a floppy disk, etc., the portable storage medium 111 is inserted into the drive device of the information processing device 113 to read the program, and the read program is stored in a storage device 114 such as RAM, a hard disk, etc. to execute the program. If a program is provided from a program provider through a communications line, the program stored in the storage device 112 of the program provider, memory, etc. is received by the information processing device through a communications line, and the received program is stored in the storage device such as RAM, a hard disk, etc., and is then executed. The program stored in the portable storage medium 111 can be one having a part of the function of the program described by referring to the above mentioned embodiments. For example, a program for realizing a part of the function of the application service provider ASP server 21 can be stored.

In the above mentioned embodiments, the portable terminal device 26 of an advertisement medium stores the URL of the Web site on which the advertising information about goods is provided as advertising data, and the URL is transmitted to the portable terminal device 27 of a consumer requesting the distribution of an advertisement. It is also possible to store all advertising data of goods in the portable terminal device 26 of an advertisement medium, and the all advertising data is distributed from the portable terminal device 26 of an advertisement medium to the portable terminal device 27 of a consumer. In this case, which advertising data the consumer has been viewed in the advertising data received from a plurality of portable terminal devices 26 of advertisement medium is, for example, determined when the advertising data is stored or when other relevant advertising data is retrieved, and the advertisement distribution and reception program of the portable terminal device 27 of a consumer notifies the application service provider ASP server 21 of the user ID of the advertisement medium who has distributed the advertising data, and gives a point to the corresponding advertisement medium.

In addition, the advertisement providing system according to the embodiments of the present invention, the application service provider ASP server 21 manages the advertising data, a user entry, etc. However, the present invention is not limited to the system using an ASP. The configuration of the advertisement providing system can be arbitrarily designed.

Furthermore, the above mentioned embodiment is realized by performing the communications between the portable terminal device 26 of an advertisement medium and the portable terminal device 27 of a consumer through Bluetooth, etc., but the communications method is not limited to this application. That is, any method capable of performing communications in a predetermined reception area can be adopted.

According to the present invention, a consumer interested in goods can immediately obtain the information, advertisement, etc. of the goods. Since the goods can be viewed as being used on or with a person, not as being displayed in a shop window, the material, the color, the actual appearance, etc. can be confirmed. Therefore, the consumer can confirm whether or not the goods look fine on him or her. From the viewpoint of a seller, conventionally, a consumer does not buy goods after taking practical action (requesting a catalog, visiting a shop, an EC site, etc.). However, according to the present invention, although a consumer does not visit a shop, the advertisement of goods can be provided for the consumer, and the advertisement can be provided immediately when he or she takes interest in goods. Therefore, the sales efficiency can be improved without losing a possible opportunity. Furthermore, since an advertisement medium who has provided the information according to which the consumer buys goods can be specified, a reward corresponding to the advertising effect can be paid to the advertisement medium.

What is claimed is:

1. An advertisement providing method, comprising:
storing in a portable terminal device advertising information about goods an advertisement medium has on or with; and
transmitting the advertising information by a wireless signal upon receipt of a request to transmit advertising information.

2. The method according to claim 1, wherein
said advertising information includes information specifying a position in a network of a server which provides advertising information about goods.

3. A portable terminal device, comprising:
a wireless signal transmission and reception unit;
a storage unit storing advertising information about goods a advertisement medium has on or with; and
a control unit instructing said wireless signal transmission and reception unit to transmit advertising information stored in said storage unit when a request to transmit advertising information is received.

4. An advertisement obtaining method, comprising:
requesting a portable terminal device for an advertisement medium to transmit advertising information;
receiving advertising information about goods the advertisement medium has on or with transmitted from said portable terminal device of the advertisement medium; and
displaying the received advertising information on the portable terminal device.

5. An advertisement obtaining method, comprising:
requesting an portable terminal device of an advertisement medium to transmit advertising information;
receiving advertising information, transmitted from the portable terminal device of an advertisement medium, about goods the advertisement medium has on or with; and
displaying the received advertising information on the portable terminal device.

6. The method according to claim 4, wherein
user-specified information received from a plurality of advertisement medium and a profile of the advertisement medium having goods on or with whose advertisement is to be obtained.

7. A portable terminal device, comprising:
wireless signal transmission and reception unit;
an advertisement request unit requesting an portable terminal device of an advertisement medium to transmit advertising information; and
a control unit instructing the wireless signal transmission and reception unit to receive advertising information, transmitted from the portable terminal device of an advertisement medium, about goods the advertisement medium has on or with, and displaying the received advertising information.

8. A computer-executable program for realizing the functions of:
storing advertising information about goods an advertisement medium has on or with in a portable terminal device; and
transmitting stored advertising information by a wireless signal when a request to transmit advertising information is received.

9. A computer-readable storage medium storing a program for realizing the functions of:
storing advertising information about goods an advertisement medium has on or with in a portable terminal device; and
transmitting stored advertising information by a wireless signal when a request to transmit advertising information is received.

10. A computer-executable program for realizing the functions of:
requesting a portable terminal device for an advertisement medium to transmit advertising information; and
receiving advertising information about goods the advertisement medium has on or with transmitted from said portable terminal device of an advertisement medium, and displaying the received advertising information on the portable terminal device.

11. A computer-readable storage medium storing a program for realizing the functions of:
requesting a portable terminal device for an advertisement medium to transmit advertising information; and
receiving advertising information about goods the advertisement medium has on or with transmitted from said portable terminal device of an advertisement medium, and displaying the received advertising information on the portable terminal device.

12. The storage medium according to claim 11, wherein
said portable terminal device has the functions of performing wireless communications with a wireless base station in a portable telephone network, and performing wireless communications with the portable terminal device.

13. An advertisement distributing method, comprising:
storing plural pieces of advertising information;
receiving a user entry of an advertisement medium;
distributing advertising information about goods to a portable terminal device of an advertisement medium who has gained user entry; and
retrieving a corresponding advertisement and distributing the advertisement to a portable terminal device of a consumer when a request to view an advertisement is received according to advertising information transmitted from the portable terminal device of an advertisement medium to the portable terminal device of a consumer.

14. A computer-executable program for realizing the functions of:
storing plural pieces of advertising information;
receiving a user entry of an advertisement medium;
distributing advertising information about goods to a portable terminal device of an advertisement medium who has gained user entry; and
retrieving a corresponding advertisement and distributing the advertisement to a portable terminal device of a consumer when a request to view the advertisement is received according to advertising information transmitted from the portable terminal device of an advertisement medium to the portable terminal device of the consumer.

15. An advertisement distributing method, comprising:
storing plural pieces of advertising information;
distributing advertising information about goods at a request of an advertisement medium to a portable terminal device; and
giving an advertising reward to the advertisement medium who has provided the advertising information when a consumer views an advertisement or buys the goods after receiving the advertising information and according to the advertising information transmitted from a portable terminal device of the advertisement medium to the portable terminal device of the consumer.

16. An advertisement distributing method, comprising:
storing plural pieces of advertising information; and
receiving a user entry of an advertisement medium,
distributing advertising information about goods to a portable terminal device of the advertisement medium who has gained user entry, and realizing the function of requesting transmission of advertising information or transmitting advertising information between the portable terminal device of the advertisement medium and the portable terminal device of a consumer.

17. A advertisement distributing method, comprising:
storing plural pieces of advertising information;
receiving a user entry of an advertisement medium;
distributing advertising information about goods to a portable terminal device of the advertisement medium who has gained user entry; and
retrieving a corresponding advertisement and distributing the advertisement to a portable terminal device of a consumer when a request to view the advertisement is issued from the portable terminal device of the consumer with the advertising information and user-specified information for designation of the advertisement medium specified.

18. An advertisement distributing method, comprising:
storing plural pieces of advertising information;
receiving a user entry of an advertisement medium;
retrieving advertising information of corresponding goods when a request to view advertising information is received from a portable terminal device of a consumer containing user-specified information about an advertisement medium and a retrieval condition of goods; and
distributing the advertising information obtained by the retrieval to the portable terminal device of the consumer.

19. The method according to claim 18, wherein
said user information comprises user-specified information, information designating whether or not an advertisement can be distributed, a term of distribution, and information designating access destination for advertising information.

20. An advertisement distributing method, comprising:
storing plural pieces of advertising information;
accepting user entry of an advertisement medium;
storing user-specified information and a profile about the advertisement medium who has gained the user entry, and advertisement specified information for designation of advertising information about goods the advertisement medium has on or with; and
retrieving the advertisement medium having a matching or similar profile to a profile specified by a consumer from information about the entered advertisement medium and distributing advertising information of goods the advertisement medium has on or with to a portable terminal device of the consumer when a request to view an advertisement with the user specified information and the profile of the advertisement medium specified by the consumer is received from the portable terminal device of the consumer.

21. The method according to claim 20, wherein
a profile matching or similar to the profile of an advertisement medium specified by the consumer is retrieved;
advertisement specified information stored as associated with the advertisement medium having matching or similar profile specified by the consumer is obtained; and
advertising information specified by the obtained advertisement specified information is retrieved, and the advertising information obtained by the retrieval is distributed to the portable terminal device of the consumer.

22. A advertisement distributing method, comprising:
storing plural pieces of advertising information;
accepting a user entry of an advertisement medium and a consumer, and storing user-specified information about the advertisement medium who has gained the user entry, goods specified information designating goods the advertisement medium has on or with, user-specified information about the consumer who has gained the user entry, and a profile of the consumer;
retrieving the goods specified information designating the goods the advertisement medium has on or with corresponding to the user-specified information about the advertisement medium, and the profile of the consumer corresponding to the user-specified information about the consumer;
obtaining advertising information matching the profile of the consumer based on the retrieval result; and
distributing the obtained advertising information to a portable terminal device of a consumer.

23. An advertisement distribution device, comprising:
an advertisement storage unit storing plural pieces of advertising information;
an entry unit accepting a user entry of an advertisement medium;
an advertisement distribution unit distributing advertising information about goods to a portable terminal device of an advertisement medium who has gained the user entry; and
a retrieval/distribution unit retrieving a corresponding advertising information from said advertisement storage unit, and distributing the advertising information to a portable terminal device of a consumer.

24. An advertisement distribution device, comprising:
an advertisement storage unit storing plural pieces of advertising information;
an entry unit accepting a user entry of an advertisement medium;
a user information storage unit storing a profile and user-specified information about the advertisement medium who has gained the user entry, and advertisement specified information designating advertising information about goods the advertisement medium has on or with; and
retrieving the advertisement medium having a matching or similar profile to a profile specified by a consumer from said user information storage unit and distributing advertising information of goods the advertisement medium has on or with to a portable terminal device of a consumer when a request to view an advertisement with user-specified information and the profile of the advertisement medium specified by the consumer is received from the portable terminal device of the consumer.
